(19) United States
(12) Patent Application Publication
(10) Pub. No.: US 2021/0398045 A1
(43) Pub. Date: Dec. 23, 2021

(54) SYSTEMS FOR SUPPLY CHAIN DATA FROM AUTONOMOUS VEHICLES

(71) Applicant: TRUCKL LLC, Dallas, TX (US)

(72) Inventor: Hanns-Christian Leemon Hanebeck, Dallas, TX (US)

(21) Appl. No.: 17/268,944

(22) PCT Filed: Jul. 30, 2019
(86) PCT No.: PCT/US2019/044247

§ 371 Date: Feb. 16, 2021

Related U.S. Application Data
(60) Provisional application No. 62/719,227, filed on Aug. 17, 2018.
(60) Provisional application No. 62/719,608, filed on Aug. 17, 2018.

(51) Int. Cl. G06Q 10/06; G06F 16/23; G06Q 10/08

(52) U.S. Cl. CPC G06Q 10/06315; G06Q 10/087; G06F 16/2379

(57) ABSTRACT

Systems for supply chain management utilizing autonomous vehicles are provided. The systems perform capturing, formatting, processing, analysis, storage, and sharing of supply chain event data. The systems store the supply chain event data relating to an execution of a supply chain process therein. In some embodiments the systems provided comprise a distributed ledger.

### BACKGROUND ART

The inventor of the present and related inventions has recognized problems unaddressed in the art regarding the operation of autonomous vehicles for the movement of materials or humans or the operation of an autonomous vehicle itself. Autonomous vehicles, by definition, are intended to operate without, or with minimal human intervention. While autonomous vehicles may be a positive development regarding the operational efficiency of vehicles on the road or of machines that move materials or passengers, their uses leave an area of operations uncovered, namely activities or business processes related to things that have to happen when an autonomous vehicle is not operating autonomously. For example, in supply chain management a human operator may need to oversee loading and unloading of materials when they are picked up or dropped off. If the processes in this example remain unchecked, errors and mistakes are likely to occur at a higher frequency than when human operators are involved throughout. Another example is that a human operator may need to check materials for damages while on route to a delivery point after hitting a series of pot holes on the road. This activity will not be possible when there is no human operator on an autonomous vehicle. In addition to checking the condition of materials, passengers or the autonomous vehicle itself, there are other areas that are currently not handled properly in the art including, but not limited to, generating alerts when exception conditions arise, dynamic or continuous adjustment of estimated time of arrival values, monitoring of temperature conditions for temperature sensitive freight, or automated updates for enterprise-class systems in regard to the operation of an autonomous vehicle. What is needed therefore are systems and methods for the capture, formatting, processing, analysis, storage, or sharing of event data in regard to the operation of autonomous vehicles.

### SUMMARY OF INVENTION

These and other problems in the art are overcome by the systems and related methods for the capture, formatting, processing, analysis, storage, or sharing of event data in regard to the operation of autonomous vehicles presented herein. A supply chain event is the occurrence of a state and specifically the state of a person or an object relevant to the execution of a supply chain process. For example, a commercial vehicle may need to be loaded with freight. As long as human operators are present during the operation, there is an authority who can verify that the loading has been conducted properly, that all expected materials have been included and that they have been secured to a trailer in the right way. When an autonomous vehicle arrives at a loading dock without a human operator, a different means to validate that the proper loading has taken place becomes necessary. The present invention comprises of systems and related methods to use one or more computing systems for this purpose in the above example, an image or video capture device mounted in the back of a trailer may collect data allowing the verification of a loading process by the same computing system, by a different computing system or by a human or machine operator remotely observing the loading process as it occurs or afterwards. There are a multitude of other situations including, but not limited to, the entry and exit of passengers in a ride sharing autonomous vehicle, the operation of autonomous vehicles in agriculture or a sea port, condition reporting about an autonomous vehicle while it operates, condition reporting on trailers or containers such as temperature or barometric monitoring, checking on the condition of freight after an autonomous vehicle comes to an unexpected or abrupt stop, or monitoring of the progress an autonomous vehicle makes towards a destination. The event data that is collected, processed, formatted, analyzed, stored, or shared by one or more computing systems in regard to the operation of an autonomous vehicle may be very valuable to operators of successive processes as well. For example, a delay in the delivery of freight may have consequences on a manufacturing process that requires the freight as input materials into the production of a product. With sufficient notice, for example, a manufacturing line may be set up to produce a different product until the needed input materials arrive at the manufacturing line. Another important aspect is that an autonomous vehicle event management system allows an autonomous vehicle to monitor the environment in which it operates through cameras or other sensors. In this manner, an autonomous vehicle may be able to report on road accidents or unforeseen obstacles it encounters on the road despite not being directly involved, or it may report the conditions of weather or traffic back to an event management system in near real-time to improve the routing for other autonomous vehicles. Another important aspect of an autonomous vehicle event management system is that an autonomous vehicle may be able to report exception conditions such as a breakdown or heavy wear on components of the autonomous vehicle itself much sooner and faster than human operators of non-autonomous vehicles might. When an autonomous vehicle is operating, the problem of how to address things such as a flat tire or worn mechanical part is much harder to solve as there may not be a human operator nearby who would be able to coordinate repair or maintenance efforts locally. This puts a large part of the responsibility on machine or human operators who may be far away from the autonomous vehicle itself. While an event management system for autonomous vehicles may not address the problem of conducting a repair process, a necessary first step to a resolution is to know when an exception condition has occurred and what exactly has happened. Further, an important part of such an autonomous vehicle event management system is the ability to capture, format, process, analyze, store, or share data in a way that allows all parties involved to trust the data comprised on the system.

The present disclosure provides a system for supply chain event management utilizing an autonomous vehicle, comprising: (a) a computing system capturing first event data during the execution of a supply chain process, and obtaining first and second attributes of the supply chain process, (b) the computing system making a first determination to either maintain a first course of action in the supply chain process or to change the first course of action in the supply chain process utilizing the first event data and the first and second attributes, and (c) the computing system generating a first record having the first event data, the first and second attributes, and the first determination, and storing the first record therein.

In some embodiments the computing system further displays the first record, and receives input data that indicates a second determination relating to the first course of action of the supply chain process, the computing system operably communicates with an external data source, the computing system obtains a third attribute of the supply chain process from the external data source, and the computing system generates a second record having the first event data, the first, second and third attributes, and the first and second determinations, and stores the second record therein.

In further embodiments the execution of the supply chain process is performed by a supply chain asset that is self-operating or human-operable.

In particular embodiments the first event data comprises raw data, and the first record comprises processed data.

In additional embodiments the computing system captures second event data during the execution of the supply chain process, and obtains third and fourth attributes of the supply chain process, the computing system makes a second determination to either maintain a second course of action in the supply chain process or to change the second course of action in the supply chain process utilizing the second event data and the third and fourth attributes and the computing system generates a second record having the second event data, the third and fourth attributes, and the second determination, and stores the second record therein.

In further embodiments the first event data comprises raw data, and the first record comprises processed data, and the first and second records comprise meta event data.

In still further embodiments the computing system comprises first, second, third, and fourth computers that operably communicate with one another, the first computer captures the first event data during the execution of the supply chain process, and obtains the first attribute of the supply chain process that is stored therein, the first computer sends a first message to the second computer, the first message having the first event data and the first attribute of the supply chain process therein, the second computer sends a second message to the fourth computer in response to the first message, the second message having the first attribute and requesting the second attribute of the supply chain process from the fourth computer, the fourth computer obtains the second attribute stored therein utilizing the first attribute in response to the second message, and sends a third message to the second computer having the second attribute therein in response to the second message, the second computer sends a fourth message to the third computer, the fourth message having the first event data and the first and second attributes of the supply chain process therein, the third computer makes the first determination to either maintain the first course of action in the supply chain process or to change the first course of action in the supply chain process utilizing the first event data and the first and second attributes, the third computer generates the first record having the first event data, the first and second attributes, and the first determination, and sends a fifth message having the first record therein to the fourth computer and the fourth computer stores the first record therein in response to the fifth message.

In additional embodiments the computing system further comprises fifth and sixth computers that operably communicate with the first, second, third, and fourth computers, the fifth computer displays the first record, and receives the input data that indicates the second determination relating to the first course of action of the supply chain process, and sends a seventh message having the second determination to the third computer, the sixth computer operably communicates with an external data source, the sixth computer obtains a third attribute of the supply chain process from the external data source, the sixth computer sends an eighth message having the third attribute therein to the third computer and the third computer generates a second record having the first event data, the first, second and third attributes, and the first and second determinations, and storing the second record therein.

In some embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the third computer making the first determination to either maintain the first course of action or to change the first course of action based on the digital photograph of the supply chain process, the process identifier, and the description of the supply chain process.

In additional embodiments the computing system comprises first, second, and third computers operably communicating with one another, the first computer captures the first event data during the execution of the supply chain process, and obtains the first attribute of the supply chain process that is stored therein, the first computer sends a first message to the second computer, the first message having the first event data and the first attribute of the supply chain process therein, the second computer sends a second message to the third computer in response to the first message, the second message having the first attribute and requesting the second attribute of the supply chain process from the third computer, the third computer obtains the second attribute stored therein utilizing the first attribute in response to the second message, the third computer sends a third message to the second computer having the second attribute therein in response to the second message, the second computer makes the first determination to either maintain the first course of action in the supply chain process or to change the first course of action in the supply chain process utilizing the first event data and the first and second attributes, the second computer generates a first record having the first event data, the first and second attributes, and the first determination, and sends a fourth message having the first record therein to the third computer and the third computer stores the first record therein in response to the fourth message.

In particular embodiments the computing system further comprises fourth and fifth computers that operably communicate with the second computer, the fourth computer displays the first record, and receives the input data that indicates the second determination relating to the first course of action of the supply chain process, and sends a sixth message having the second determination to the second computer, the fifth computer operably communicates with an external data source, the fifth computer obtains a third attribute of the supply chain process from the external data source, the fifth computer sends a seventh message with the third attribute therein to the second computer and the second computer generates a second record having the first event data, the first, second and third attributes, and the first and second determinations, and storing the second record therein.

In further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In still further embodiments the computing system comprises first and second computers operably communicating with one another, the first computer captures the first event data of a supply chain process, and obtains a first attribute of the supply chain process that is stored therein, the first computer sends a first message to the second computer, the first message having the first event data and the first attribute therein, the second computer obtains a second attribute of the supply chain process stored therein utilizing the first attribute in response to the first message, the second computer makes a first determination to either maintain a first course of action in the supply chain process or to change the first course of action in the supply chain process utilizing the first event data and the first and second attributes, the second computer generates a first record having the first event data, the first and second attributes, and the first determination and the second computer stores the first record therein.

In yet further embodiments the computing system further comprises third and fourth computers that operably communicate with the second computer, the third computer displays the first record, and receives the input data that indicates a second determination relating to the first course of action of the supply chain process, and sends a third message having the second determination to the second computer, the fourth computer operably communicates with an external data source, the fourth computer obtains a third attribute of the supply chain process from the external data source, the fourth computer sends a fourth message to the second computer with the third attribute therein and the second computer generates a second record having the first event data, the first, second and third attributes, and the first and second determinations, and stores the second record therein.

In additional embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In some embodiments the computing system comprises first and second computers operably communicating with one another, the first computer captures the first event data of the supply chain process and obtains the first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain the first course of action in the supply chain process or to change the first course of action in the supply chain process utilizing the first event data and the first and second attributes, the first computer generates the first record having the first event data, the first and second attributes, and the first determination, the first computer sends a third message having the first record therein to the second computer and the second computer stores the first record therein in response to the third message.

In additional embodiments the computing system further comprises third and fourth computers that operably communicate with the second computer, the third computer displays the first record, and receives the input data that indicates a second determination relating to the first course of action of the supply chain process, and sends a fifth message having the second determination therein to the second computer, the fourth computer operably communicates with an external data source, the fourth computer obtains a third attribute of the supply chain process from the external data source, the fourth computer sends a sixth message having the third attribute therein to the second computer and the second computer generates a second record having the first event data, the first, second and third attributes, and the first and second determinations, and stores the second record therein.

In particular embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In other embodiments the computing system comprises a first computer capturing the first event data of the supply chain process, and obtains the first and second attributes of the supply chain process that are stored therein, the first computer makes the first determination to either maintain the first course of action in the supply chain process or to change the first course of action in the supply chain process utilizing the first event data and the first and second attributes and the first computer generates the first record having the first event data, the first and second attributes, and the first determination, and storing the first record therein.

In some embodiments the computing system further comprises second and third computers that operably communicate with the first computer, the second computer displays the first record, and receives the input data that indicates a second determination relating to the first course of action of the supply chain process, and sends a second message having the second determination therein to the first computer, the third computer operably communicates with an external data source, the third computer obtains a third attribute of the supply chain process from the external data source, the third computer sends a third message having the third attribute therein to the first computer and the first computer generates a second record having the first event data, the first, second and third attributes, and the first and second determinations, and storing the second record therein.

In further embodiments the computing system further comprises a second computer that operably communicates with the first computer, the second computer displays the first record, and receives the input data that indicates a second determination relating to the first course of action of the supply chain process, and sends a second message having the second determination therein to the first computer, the first computer further operably communicates with an external data source, the first computer obtains a third attribute of the supply chain process from the external data source and the first computer generates a second record having the first event data, the first, second and third attributes, and the first and second determinations, and storing the second record therein.

In still further embodiments the first computer displays the first record, and receives the input data that indicates a second determination relating to the first course of action of the supply chain process, the first computer further operably communicates with an external data source, the first computer obtains a third attribute of the supply chain process from the external data source and the first computer generates a second record having the first event data, the first, second and third attributes, and the first and second determinations, and storing the third record therein.

In yet further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the first computer makes the first determination to either maintain the first course of action or to change the first course of action based on the digital photograph of the supply chain process, the process identifier, and the description of the supply chain process.

The present disclosure further provides a system for supply chain event management utilizing an autonomous vehicle, comprising: (a) a first computer capturing first event data of a supply chain process, and obtaining first and second attributes of the supply chain process that are stored therein, (b) the first computer making a first determination to either maintain a first course of action in the supply chain process or to change the first course of action in the supply chain process utilizing the first event data and the first and second attributes and (c) the first computer generating a first record having the first event data, the first and second attributes, and the first determination, and storing the first record therein.

In some embodiments the first computer operably communicates with an external data source, the first computer obtains a third attribute of the supply chain process from the external data source and the first computer generates a second record having the first event data, the first, second and third attributes, and the first and second determinations, and storing the second record therein.

In additional embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the first computer makes the first determination to either maintain the first course of action or to change the first course of action based on the digital photograph of the supply chain process, the process identifier, and the description of the supply chain process.

The present disclosure additionally provides a system for supply chain event management utilizing an autonomous vehicle, comprising: (a) a computing system operably communicating, with a distributed ledger computer, the distributed ledger computer being a node of a distributed ledger, (b) the computing system capturing first event data during the execution of a supply chain process, and obtaining first and second attributes of the supply chain process, (c) the computing system making a first determination to either maintain a first course of action in the supply chain process or to change the first course of action in the supply chain process utilizing the first event data and the first and second attributes, (d) the computing system generating a first record having the first event data, the first and second attributes, and the first determination, and storing the first record therein, (e) the computing system sending the first record to the distributed ledger computer and (f) the distributed ledger computer adding the first record to a first block and broadcasting the first block to a plurality of nodes of the distributed ledger to validate and store the first block on the distributed ledger.

In further embodiments the computing system further calculates a hash value of the first record, the computing system sends the hash value to the distributed ledger computer, the distributed ledger computer adds the hash value to a second block and broadcasts the second block to the plurality of nodes of the distributed ledger to validate and store of the second block on the distributed ledger.

In yet further embodiments the computing system further displays the first record, and receives input data that indicates a second determination relating to the first course of action of the supply chain process, the computing system operably communicates with an external data source, the computing system obtains a third attribute of the supply chain process from the external data source, the computing system generates a second record having the first event data, the first, second and third attributes, and the first and second determinations, and storing the second record therein, the computing system sends the second record to the distributed ledger computer and the distributed ledger computer adds the second record to a second block and broadcasts the second block to the plurality of nodes of the distributed ledger to validate and store the second block on the distributed ledger.

In still further embodiments the distributed ledger is at least one of a private distributed ledger or a public distributed ledger.

In additional embodiments the execution of the supply chain process is performed by a supply chain asset that is self-operating or human-operable.

In particular embodiments the first event data comprises raw data, and the first record comprises processed data.

In some embodiments the computing system captures second event data during the execution of the supply chain process, and obtains third and fourth attributes of the supply chain process, the computing system makes a second determination to either maintain a second course of action in the supply chain process or to change the second course of action in the supply chain process utilizing the second event data and the third and fourth attributes, the computing system generates a second record having the second event data, the third and fourth attributes, and the second determination, and stores the second record therein, the computing system sends the second record to the distributed ledger computer and the distributed ledger computer adds the second record to a second block and broadcasts the second block to the plurality of nodes of the distributed ledger to validate and store the second block on the distributed ledger.

In other embodiments the first event data comprises raw data, and the first record comprises processed data, and the first and second records comprise meta event data.

In still other embodiments the computing system comprises first, second, third, and fourth computers operably communicating with one another, the third and fourth computer operably communicating with the distributed ledger computer, the first computer captures the first event data during the execution of the supply chain process, and obtains the first attribute of the supply chain process that is stored therein, the first computer sends a first message to the second computer, the first message having the first event data and the first attribute of the supply chain process therein, the second computer sends a second message to the fourth computer in response to the first message, the second message having the first attribute and requesting the second attribute of the supply chain process from the fourth computer, the fourth computer obtains the second attribute stored therein utilizing the first attribute in response to the second message, and sends a third message to the second computer having the second attribute therein in response to the second message, the second computer sends a fourth message to the third computer; the fourth message having the first event data and the first and second attributes of the supply chain process therein, the third computer makes the first determination to either maintain the first course of action in the supply chain process or to change the first course of action in the supply chain process utilizing the first event data and the first and second attributes, the third computer generates the first record having the first event data, the first and second attributes, and the first determination, and sends a fifth message having the first record therein to the fourth computer, and sends a sixth message having the first record therein to the distributed ledger computer, the fourth computer stores the first record therein in response to the sixth message and the distributed ledger computer adds the first record to the first block and broadcasts the first block to the plurality of nodes of the distributed ledger to validate and store the first block on the distributed ledger, in response to the sixth message.

In further embodiments the third computer further calculates a hash value of the first record, the third computer sends a seventh message having the hash value therein to the distributed ledger computer and the distributed ledger computer adds the hash value to the second block and broadcasts the second block to the plurality of nodes of the distributed ledger to validate and store the second block on the distributed ledger, in response to the seventh message.

In yet further embodiments the computing system further comprises fifth and sixth computers that operably communicate with the first, second, third, and fourth computers, the fifth computer displays the first record, and receives the input data that indicates the second determination relating to the first course of action of the supply chain process, and sends a seventh message having the second determination to the third computer, the sixth computer operably communicates with an external data source, the sixth computer obtains a third attribute of the supply chain process from the external data source, the sixth computer sends an eighth message having the third attribute therein to the third computer, the third computer generates a second record having the first event data, the first, second and third attributes, and the first and second determinations, and stores the second record therein, the computing system sends a ninth message having the second record therein to the distributed ledger computer and the distributed ledger computer adds the second record to a second block and broadcasts the second block to the plurality of nodes of the distributed ledger to validate and store the second block on the distributed ledger.

In still further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the third computer makes the first determination to either maintain the first course of action or to change the first course of action based on the digital photograph of the supply chain process, the process identifier, and the description of the supply chain process.

In additional embodiments the computing system comprises first, second, and third computers operably communicating with one another, the third computer operably communicates with the distributed ledger computer, the first computer captures the first event data during the execution of the supply chain process, and obtains the first attribute of the supply chain process that is stored therein, the first computer sends a first message to the second computer, the first message having the first event data and the first attribute of the supply chain process therein, the second computer sends a second message to the third computer in response to the first message, the second message having the first attribute and requesting the second attribute of the supply chain process from the third computer, the third computer obtains the second attribute stored therein utilizing the first attribute in response to the second message, the third computer sends a third message to the second computer having the second attribute therein in response to the second message, the second computer makes the first determination to either maintain the first course of action in the supply chain process or to change the first course of action in the supply chain process utilizing the first event data and the first and second attributes, the second computer generates a first record having the first event data, the first and second attributes, and the first determination, and sends a fourth message having the first record therein to the third computer, and sends a fifth message having the first record therein to the distributed ledger computer, the third computer stores the first record therein in response to the fourth message and the distributed ledger computer adds the first record to the first block and broadcasts the first block to the plurality of nodes of the distributed ledger to validate and store the first block on the distributed ledger, in response to the fifth message.

In some embodiments the second computer further calculates a hash value of the first record, the second computer sends a sixth message having the hash value therein to the distributed ledger computer and the distributed ledger computer adds the hash value to a second block and broadcasts the second block to the plurality of nodes of the distributed ledger to validate and store the second block on the distributed ledger, in response to the sixth message.

In certain embodiments the computing system further comprises fourth and fifth computers that operably communicate with the second computer, the fourth computer displays the first record, and receives the input data that indicates the second determination relating to the first course of action of the supply chain process, and sends a sixth message having the second determination to the second computer, the fifth computer operably communicates with an external data source, the fifth computer obtains a third attribute of the supply chain process from the external data source, the fifth computer sends a seventh message with the third attribute therein to the second computer, the second computer generates a second record having the first event data, the first, second and third attributes, and the first and second determinations, and storing the second record therein, the second computer sends an eighth message having the second record therein to the distributed ledger computer and the distributed ledger computer adds the second record to a second block and broadcasts the second block to the plurality of nodes of the distributed ledger to validate and store the second block on the distributed ledger.

In further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In yet further embodiments the computing system comprises first and second computers operably communicating with one another, the second computer operably communicates with the distributed ledger computer, the first computer captures the first event data of a supply chain process, and obtains a first attribute of the supply chain process that is stored therein, the first computer sends a first message to the second computer, the first message having the first event data and the first attribute therein, the second computer obtains a second attribute of the supply chain process stored therein utilizing the first attribute in response to the first message, the second computer makes a first determination to either maintain a first course of action in the supply chain process or to change the first course of action in the supply chain process utilizing the first event data and the first and second attributes, the second computer generates a first record having the first event data, the first and second attributes, and the first determination, the second computer stores the first record therein, the second computer sends a second message having the first record therein to the distributed ledger computer and the distributed ledger computer adds the first record to the first block and broadcasts the first block to the plurality of nodes of the distributed ledger to validate and store the first block on the distributed ledger, in response to the second message.

In still further embodiments the second computer calculates a hash value of the first record, the second computer sends a third message having the hash value therein to the distributed ledger computer and the distributed ledger computer adds the hash value to a second block and broadcasts the second block to the plurality of nodes of the distributed ledger to validate and store the second block on the distributed ledger, in response to the third message.

In some embodiments the computing system further comprises third and fourth computers that operably communicate with the second computer, the third computer displays the first record, and receives the input data that indicates a second determination relating to the first course of action of the supply chain process, and sends a third message having the second determination to the second computer, the fourth computer operably communicates with an external data source, the fourth computer obtains a third attribute of the supply chain process from the external data source, the fourth computer sends a fourth message to the second computer with the third attribute therein, the second computer generates a second record having the first event data, the first, second and third attributes, and the first and second determinations, and stores the second record therein, the second computer sends a fifth message with the second record therein to the distributed ledger computer and the distributed ledger computer adds the second record to a second block and broadcasts the second block to the plurality of nodes of the distributed ledger to validate and store the second block on the distributed ledger.

In additional embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In particular embodiments the computing system comprises first and second computers operably communicating with one another, the second computer operably communicates with the distributed ledger computer, the first computer captures the first event data of the supply chain process and obtains the first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain the first course of action in the supply chain process or to change the first course of action in the supply chain process utilizing the first event data and the first and second attributes, the first computer generates the first record having the first event data, the first and second attributes, and the first determination, the first computer sends a third message having the first record therein to the second computer, and sends a fourth message having the first record therein to the distributed ledger computer, the second computer stores the first record therein in response to the third message and the distributed ledger computer adds the first record to the first block and broadcasts the first block to the plurality of nodes of the distributed ledger to validate and store the first block on the distributed ledger, in response to the fourth message.

In additional embodiments the first computer calculates a hash value of the first record, the first computer sends a fifth message having the hash value therein to the distributed ledger computer and the distributed ledger computer adds the hash value to a second block and broadcasts the second block to the plurality of nodes of the distributed ledger to validate and store the second block on the distributed ledger, in response to the fifth message.

In some embodiments the computing system further comprises third and fourth computers that operably communicate with the second computer, the third computer displays the first record, and receives the input data that indicates a second determination relating to the first course of action of the supply chain process, and sends a fifth message having the second determination therein to the second computer, the fourth computer operably communicates with an external data source, the fourth computer obtains a third attribute of the supply chain process from the external data source, the fourth computer sends a sixth message having the third attribute therein to the second computer, the second computer generates a second record having the first event data, the first, second and third attributes, and the first and second determinations, and stores the second record therein, the second computer sends a seventh message having the third record therein to the distributed ledger computer and the distributed ledger computer adds the second record to a second block and broadcasts the second block to the plurality of nodes of the distributed ledger to validate and store the second block on the distributed ledger.

In further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the second computer makes the first determination to either maintain the first course of action or to change the first course of action based on the digital photograph of the supply chain process, the process identifier, and the description of the supply chain process.

In yet further embodiments the computing system comprises a first computer operably communicating with the distributed ledger computer, the first computer captures the first event data of the supply chain process, and obtains the first and second attributes of the supply chain process that are stored therein, the first computer makes the first determination to either maintain the first course of action in the supply chain process or to change the first course of action in the supply chain process utilizing the first event data and the first and second attributes, the first computer generates the first record having the first event data, the first and second attributes, and the first determination, and stores the first record therein, the first computer sends a first message having the first record therein to the distributed ledger computer and the distributed ledger computer adds the first record to a first block and broadcasts the first block to the plurality of nodes of the distributed ledger to validate and store the first block on the distributed ledger, in response to the first message.

In still further embodiments the first computer calculates a hash value of the first record, the first computer sends a second message having the hash value therein to the distributed ledger computer and the distributed ledger computer adds the hash value to a second block and broadcasts the second block to the plurality of nodes of the distributed ledger to validate and store the second block on the distributed ledger, in response to the second message.

In some embodiments the computing system further comprises second and third computers that operably communicate with the first computer, the second computer displays the first record, and receives the input data that indicates a second determination relating to the first course of action of the supply chain process, and sends a second message having the second determination therein to the first computer, the third computer operably communicates with an external data source, the third computer obtains a third attribute of the supply chain process from the external data source, the third computer sends a third message having the third attribute therein to the first computer, the first computer generates a second record having the first event data, the first, second and third attributes, and the first and second determinations, and stores the second record therein, the first computer sends a fourth message having the second record therein to the distributed ledger computer and the distributed ledger computer adds the second record to a second block and broadcasts the second block to the plurality of nodes of the distributed ledger to validate and store the second block on the distributed ledger.

In additional embodiments the computing system further comprises a second computer that operably communicates with the first computer, the second computer displays the first record, and receives the input data that indicates a second determination relating to the first course of action of the supply chain process, and sends a second message having the second determination therein to the first computer, the first computer further operably communicates with an external data source, the first computer obtains a third attribute of the supply chain process from the external data source, the first computer generates a second record having the first event data, the first, second and third attributes, and the first and second determinations, and stores the second record therein, the first computer sends a fourth message having the second record therein to the distributed ledger computer and the distributed ledger computer adds the second record to a second block and broadcasts the second block to the plurality of nodes of the distributed ledger to validate and store the second block on the distributed ledger.

In some embodiments the first computer displays the first record, and receives the input data that indicates a second determination relating to the first course of action of the supply chain process, the first computer further operably communicates with an external data source, the first computer obtains a third attribute of the supply chain process from the external data source, the first computer generates a second record having the first event data, the first, second and third attributes, and the first and second determinations, and stores the third record therein, the first computer sends a fourth message having the second record therein to the distributed ledger computer and the distributed ledger computer adds the second record to a second block and broadcasts the second block to the plurality of nodes of the distributed ledger to validate and store the second block on the distributed ledger.

In certain embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the first computer makes the first determination to either maintain the first course of action or to change the first course of action based on the digital photograph of the supply chain process, the process identifier, and the description of the supply chain process.

The present disclosure further provides a system for supply chain event management utilizing an autonomous vehicle, comprising. (a) a first computer captures first event data of a supply chain process, and obtains first and second attributes of the supply chain process that are stored therein, (b) the first computer makes a first determination to either maintain a first course of action in the supply chain process or to change the first course of action in the supply chain process utilizing the first event data and the first and second attributes, (c) the first computer generates a first record having the first event data, the first and second attributes, and the first determination, and stores the first record therein and (d) the first computer adds the first record to a first block and broadcasts the first block to the plurality of nodes of a distributed ledger to validate and store the first block on the distributed ledger.

In particular embodiments the first computer calculates a hash value of the first record and the first computer adds the hash value to a second block and broadcasts the second block to the plurality of nodes of the distributed ledger to validate and store the second block on the distributed ledger.

In further embodiments the first computer operably communicates with an external data source, the first computer obtains a third attribute of the supply chain process from the external data source, the first computer generates a second record having the first event data, the first, second and third attributes, and the first and second determinations, and stores the second record therein and the first computer adds the second record to a second block and broadcasts the second block to the plurality of nodes of the distributed ledger to validate and store the second block on the distributed ledger.

In yet further embodiments the supply chain process is a transport of freight, the first event data is a digital photograph captured during the supply chain process, the first attribute is a process identifier of the supply chain process, the second attribute is a second record providing a description of the supply chain process, the first course of action is a transport of freight by the supply chain asset from a departure location to a destination location and the first computer makes the first determination to either maintain the first course of action or to change the first course of action based on the digital photograph of the supply chain process, the process identifier, and the description of the supply chain process.

The present disclosure additionally provides a system for supply chain event management utilizing an autonomous vehicle, comprising: (a) a computing system that operably communicates with first and second distributed ledger computers, the first distributed ledger computer being a node of a first distributed ledger, the second distributed ledger computer being a node of a second distributed ledger, (b) the computing system capturing first event data of a supply chain process, and obtaining a first attribute of the supply chain process that is stored therein, (c) the computing system obtaining a second attribute of the supply chain process utilizing the first attribute, (d) the computing system making a first determination to either maintain a first course of action in the supply chain process or to change the first course of action in the supply chain process utilizing the first event data and the first and second attributes, (e) the computing system generating a first record having the first event data, the first and second attributes, and the first determination, (f) the computing system calculating a hash value of the first record, (g) the first distributed ledger computer adding the hash value to a first block and broadcasting the first block to a plurality of nodes of the first distributed ledger to validate and store the first block on the first distributed ledger and (h) the second distributed ledger computer adding the hash value to a second block and broadcasting the second block to a plurality of nodes of the second distributed ledger to validate and store the second block on the second distributed ledger.

In some embodiments the computing system comprises first and second computers operably communicating with one another; the second computer operably communicates with the first and second distributed ledger computers, the first computer captures the first event data of the supply chain process, and obtains the first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain the first course of action in the supply chain process or to change the first course of action in the supply chain process utilizing the first event data and the first and second attributes, the first computer generates the first record having the first event data, the first and second attributes, and the first determination, the first computer further calculates the hash value of the first record, the first computer sends a third message having the hash value to the first distributed ledger computer, and a fourth message having the hash value to the second distributed ledger computer, the first distributed ledger computer adds the hash value to the first block and broadcasts the first block to the plurality of nodes of the first distributed ledger to validate and store the first block on the first distributed ledger in response to the third message and the second distributed ledger computer adds the hash value to the second block and broadcasts the second block to the plurality of nodes of the second distributed ledger to validate and store the second block on the second distributed ledger in response to the fourth message.

The present disclosure further provides a system for supply chain event management utilizing an autonomous vehicle, comprising (a) a computing system that operably communicates with first and second distributed ledger computers, the first distributed ledger computer being a node of a first distributed ledger, the second distributed ledger computer being a node of a second distributed ledger, (b) the computing system capturing first event data of a supply chain process, and obtaining a first attribute of the supply chain process that is stored therein, (c) the computing system obtaining a second attribute of the supply chain process utilizing the first attribute, (d) the computing system making a first determination to either maintain a first course of action in the supply chain process or to change the first course of action in the supply chain process utilizing the first event data and the first and second attributes, (e) the computing system generating a first record having the first event data, the first and second attributes, and the first determination, (f) the computing system splitting the first record into second and third records (g) the computing system calculating a first hash value of the second record, and sending the first hash value to the first distributed ledger computer, (h) the computing system calculating a second hash value of the third record, and sending the second hash value to the second distributed ledger computer, (i) the first distributed ledger computer adding the first hash value to a first block and broadcasting the first block to a plurality of nodes of the first distributed ledger to validate and store the first block on the first distributed ledger and (j) the second distributed ledger computer adding the second hash value to a second block and broadcasting the second block to a plurality of nodes of the second distributed ledger to validate and store the second block on the second distributed ledger.

In some embodiments the computing system includes first and second computer operably communicating with one another, the second computer operably communicates with the first and second distributed ledger computers, the first computer captures the first event data of the supply chain process, and obtains the first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain a first course of action in the supply chain process or to change the first course of action in the supply chain process utilizing the first event data and the first and second attributes, the first computer generates the first record having the first event data, the first and second attributes, and the first determination, the first computer splits the first record into second and third records, the first computer calculates a first hash value of the second record, and sends a third message with the first hash value therein to the first distributed ledger computer, the first computer calculates a second hash value of the third record, and sends a fourth message with the second hash value therein to the second distributed ledger computer, the first distributed ledger computer adds the first hash value to a first block and broadcasts the first block to a plurality of nodes of the first distributed ledger to validate and store the first block on the first distributed ledger, in response to the third message and the second distributed ledger computer adds the second hash value to a second block and broadcasts the second block to a plurality of nodes of the second distributed ledger to validate and store the second block on the second distributed ledger, in response to the fourth message.

The present disclosure additionally provides a system for supply chain event management utilizing an autonomous vehicle, comprising: (a) a computing system operably communicating with the first and second distributed ledger computers, the first distributed ledger computer being a node of a first distributed ledger, the second distributed ledger computer being a node of a second distributed ledger, (b) the computing system capturing first event data of a supply chain process and obtaining a first attribute of the supply chain process that is stored therein, (c) the computing system obtaining a second attribute of the supply chain process utilizing the first attribute, (d) the computing system making a first determination to either maintain a first course of action in the supply chain process or to change the first course of action in the supply chain process utilizing the first event data and the first and second attributes, (e) the computing system generating a first record having the first event data, the first and second attributes, and the first determination, (t) the computing system calculating a first hash value of the first record, and splitting the first hash value into second and third hash values, (g) the computing system sending the second hash value to the first distributed ledger computer, and sending the third hash value to the second distributed ledger computer, (h) the first distributed ledger computer adding the second hash value to a first block and broadcasting the first block to a plurality of nodes of the first distributed ledger to validate and store the first block on the first distributed ledger and (i) the second distributed ledger computer adding the third hash value to a second block and broadcasting the second block to a plurality of nodes of the second distributed ledger to validate and store the second block on the second distributed ledger.

In some embodiments the computing system includes first and second computer operably communicating with one another, the second computer operably communicates with the first and second distributed ledger computers, the first computer captures the first event data of the supply chain process and obtains the first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain the first course of action in the supply chain process or to change the first course of action in the supply chain process utilizing the first event data and the first and second attributes, the first computer generates the first record having the first event data, the first and second attributes, and the first determination, the first computer calculates the first hash value of the first record, and splits the first hash value into second and third hash values, the first computer sends a third message having the second hash value therein to the first distributed ledger computer, and sends a fourth message having the third hash value therein to the second distributed ledger computer, the first distributed ledger computer adds the second hash value to the first block and broadcasts the first block to the plurality of nodes of the first distributed ledger to validate and store the first block on the first distributed ledger, in response to the third message and the second distributed ledger computer adds the third hash value to the second block and broadcasts the second block to the plurality of nodes of the second distributed ledger to validate and store the second block on the second distributed ledger, in response to the fourth message.

The present disclosure further provides a system for supply chain event management utilizing an autonomous vehicle, comprising: (a) a computing system operably communicating with the first and second distributed ledger computers; the first distributed ledger computer being a node of a first distributed ledger, the second distributed ledger computer being a node of a second distributed ledger, (b) the computing system capturing first event data of a supply chain process and obtaining a first attribute of the supply chain process that is stored therein, (c) the computing system obtaining a second attribute of the supply chain process utilizing the first attribute, (d) the computing system making a first determination to either maintain a first course of action in the supply chain process or to change the first course of action in the supply chain process utilizing the first event data and the first and second attributes, (e) the computing system generating a first record having the first event data, the first and second attributes, and the first determination, (f) the computing system sending a third message with the first record therein to the first distributed ledger computer, and sending a fourth message with the first record therein to the second distributed ledger computer, (g) the first distributed ledger computer adding the first record to a first block and broadcasting the first block to a plurality of nodes of the first distributed ledger to validate and store the first block on the first distributed ledger, in response to the third message and (h) the second distributed ledger computer adding the first record to a second block and broadcasting the second block to a plurality of nodes of the second distributed ledger to validate and store the second block on the second distributed ledger, in response to the fourth message.

In certain embodiments the computing system includes first and second computer operably communicating with one another, the second computer operably communicates with the first and second distributed ledger computers, the first computer captures the first event data of the supply chain process and obtains the first attribute of the supply chain process that is stored therein, the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain a first course of action in the supply chain process or to change the first course of action in the supply chain process utilizing the first event data and the first and second attributes, the first computer generates the first record having the first event data, the first and second attributes, and the first determination, the first computer sends a third message with the first record therein to the first distributed ledger computer, and sends a fourth message with the first record therein to the second distributed ledger computer, the first distributed ledger computer adds the first record to the first block and broadcasts the first block to the plurality of nodes of the first distributed ledger to validate and store the first block on the first distributed ledger, in response to the third message and the second distributed ledger computer adds the first record to the second block and broadcasts the second block to the plurality of nodes of the second distributed ledger to validate and store the second block on the second distributed ledger, in response to the fourth message.

The present disclosure additionally provides a system for supply chain event management utilizing an autonomous vehicle, comprising. (a) a computing system operably communicating with the first and second distributed ledger computers; the first distributed ledger computer being a node of a first distributed ledger, the second distributed ledger computer being a node of a second distributed ledger, (b) the computing system capturing first event data of a supply chain process and obtaining a first attribute of the supply chain process that is stored therein, (c) the computing system obtaining a second attribute of the supply chain process utilizing the first attribute, (d) the computing system making a first determination to either maintain a first course of action in the supply chain process or to change the first course of action in the supply chain process utilizing the first event data and the first and second attributes, (e) the computing system generating a first record having the first event data, the first and second attributes, and the first determination, (f) the computing system splitting the first record into second and third records, (g) the computing system sending a third message with the second record therein to the first distributed ledger computer, and sending a fourth message with the third record therein to the second distributed ledger computer, (h) the first distributed ledger computer adding the second record to a first block and broadcasting the first block to a plurality of nodes of the first distributed ledger to validate and store the first block on the first distributed ledger, in response to the third message and (i) the second distributed ledger computer adding the third record to a second block and broadcasting the second block to a plurality of nodes of the second distributed ledger to validate and store the second block on the second distributed ledger, in response to the fourth message.

In particular embodiments the computing system includes first and second computer operably communicating with one another, the second computer operably communicates with the first and second distributed ledger computers, the first computer captures the first event data of the supply chain process and obtains a first attribute of the supply chain process that is stored therein; the first computer sends a first message to the second computer, the first message having the first attribute therein, the second computer obtains the second attribute of the supply chain process utilizing the first attribute in response to the first message, and sends a second message to the first computer in response to the first message, the second message having the second attribute therein, the first computer makes the first determination to either maintain a first course of action in the supply chain process or to change the first course of action in the supply chain process utilizing the first event data and the first and second attributes, the first computer generates the first record having the first event data, the first and second attributes, and the first determination, the first computer splits the first record into second and third records, the first computer sends a third message with the second record therein to the first distributed ledger computer, and sends a fourth message with the third record therein to the second distributed ledger computer, the first distributed ledger computer adds the second record to the first block and broadcasts the first block to the plurality of nodes of the first distributed ledger to validate and store the first block on the first distributed ledger, in response to the third message and the second distributed ledger computer adds the third record to the second block and broadcasts the second block to the plurality of nodes of the second distributed ledger to validate and store the second block on the second distributed ledger, in response to the fourth message.

### BRIEF DESCRIPTION OF DRAWINGS

FIG. 1 is a diagram illustrating autonomous vehicle event data types;

FIG. 2 is a block diagram of a method for converting raw supply chain event data into processed supply chain event data and the use in decision-making;

FIG. 3 is a schematic of a system for supply chain event management in accordance with an exemplary embodiment;

FIG. 4 is a block diagram of a method for capturing, processing and analyzing event data in regard to the operation of an autonomous vehicle utilizing the system of FIG. 3;

FIG. 5 is a schematic of a system for supply chain event management in accordance with another exemplary embodiment;

FIG. 6 is a block diagram of a method for capturing, processing and analyzing event data in regard to the operation of an autonomous vehicle utilizing the system of FIG. 5;

FIG. 7 is a schematic of a system for supply chain event management in accordance with another exemplary embodiment;

FIG. 8 is a block diagram of a method for capturing, processing and analyzing event data in regard to the operation of an autonomous vehicle utilizing the system of FIG. 7;

FIG. 9 is a schematic of a system for supply chain event management in accordance with another exemplary embodiment,

FIG. 10 is a block diagram of a method for capturing, processing and analyzing event data in regard to the operation of an autonomous vehicle utilizing the system of FIG. 9;

FIG. 11 is a schematic of a system for supply chain event management in accordance with another exemplary embodiment;

FIG. 12 is a block diagram of a method for capturing, processing and analyzing event data in regard to the operation of an autonomous vehicle utilizing the system of FIG. 11;

FIG. 13 is a schematic of a system for supply chain event management in accordance with another exemplary embodiment,

FIG. 14 is a block diagram of a method for capturing, processing and analyzing event data in regard to the operation of an autonomous vehicle utilizing the system of FIG. 13;

FIG. 15 is a schematic of a system for supply chain event management in accordance with another exemplary embodiment;

FIG. 16 is a block diagram of a method for capturing, processing and analyzing event data in regard to the operation of an autonomous vehicle utilizing the system of FIG. 15;

FIG. 17 is a schematic of a system for supply chain event management in accordance with another exemplary embodiment;

FIG. 18 is a block diagram illustrating linking data blocks on a distributed ledger using hashes;

FIG. 19 is a diagram illustrating supply chain event data types, distributed ledger types, and formats for supply chain event data;

FIG. 20 is a block diagram of a method of storing hashed supply chain event data on a public distributed ledger utilizing the system of FIG. 17;

FIG. 21 is a schematic of a system for supply chain event management in accordance with another exemplary embodiment,

FIG. 22 is a block diagram of a method for storing hashed supply chain event data on a public distributed ledger utilizing the system of FIG. 16;

FIG. 23 is a schematic of a system for supply chain event management in accordance with another exemplary embodiment;

FIG. 24 is a block diagram of a method for storing supply chain event data on two or more distributed ledgers utilizing the system of FIG. 23; and

FIG. 25 is a block diagram of a method for storing partial supply chain event data on a first distributed ledger and partial supply chain event data on a second distributed ledger utilizing the system of FIG. 23.

### DESCRIPTION OF EMBODIMENTS

Systems and related methods for the capture, formatting, processing, analysis, storage, or sharing of event data in regard to the operation of autonomous vehicles are presented herein. A supply chain event is the occurrence of a state and specifically the state of a person or an object relevant to the execution of a supply chain process utilizing a semi-autonomous or autonomous vehicle. A multitude of supply chain events and supply chain event data can be observed in every supply chain transaction utilizing a semi-autonomous or autonomous vehicle. The present invention enables a user to capture supply chain event data during the operation of an autonomous vehicle, make sense of it through the application of formatting, processing and analysis, store supply chain event data in a database and, in some embodiments of the present invention, write the supply chain event data or a hash of the supply chain event data onto a distributed ledger. For the purposes of describing the present invention, reference to “supply chain event data in regard to the operation of a semi-autonomous or autonomous vehicle” will simply referred to as “event data”, reference to “supply chain events in regard to the operation of a semi-autonomous or autonomous vehicle” will simply be referred to as “events” and reference to “semi-autonomous or autonomous vehicles” will simply be referred to as “supply chain asset” unless explicitly stated otherwise.

For example, a commercial vehicle may need to be loaded with freight. As long as human operators are present during the operation, there is an authority who can verify that the loading has been conducted properly, that all expected materials have been included and that they have been secured to a trailer in the right way. When an autonomous vehicle arrives at a loading dock without a human operator, a different means to validate that the proper loading has taken place becomes necessary. The present invention comprises of systems and related methods to use one or more computing systems for this purpose. In the above example, an image or video capture device mounted in the back of a trailer may collect data allowing the verification of a loading process by the same computing system, by a different computing system or by a human or machine operator remotely observing the loading process as it occurs or afterwards. It may also be conceivable in one embodiment of the present invention that autonomous vehicles used in passenger car applications or in ride sharing applications may autonomously drive to a grocery or similar store to autonomously pick up a purchase made online, through a phone call or based on a predetermined list of purchases and may autonomously return to the owner of the autonomous vehicle or client of the ride sharing application for delivery of the groceries or materials.

There are a multitude of other situations including, but not limited to, the entry, behavior, or exit of passengers in a ride sharing autonomous vehicle, the operation of autonomous vehicles in agriculture or a sea port, condition reporting about an autonomous vehicle while it operates, condition reporting on trailers or containers such as temperature or barometric monitoring, checking on the condition of freight after an autonomous vehicle comes to an unexpected or abrupt stop, or monitoring of the progress an autonomous vehicle makes towards a destination. The event data that is collected, processed, formatted, analyzed, stored and shared by one or more computing systems in regard to the operation of an autonomous vehicle may be very valuable to operators of successive processes as well. For example, a delay in the delivery of freight may have consequences for a manufacturing process that requires the freight as input materials into the production of a product. With sufficient notice, for example, a manufacturer may produce a different product until the needed input materials arrive at the manufacturing line. Another example for the use of the present invention is that computing devices and sensors attached to an autonomous vehicle may be used to capture, format, process, store and share data about environmental conditions. It is conceivable that an autonomous vehicle passes by the scene of an accident on the other side of the road. Cameras mounted to the autonomous vehicle may capture images of the accident and alert first responders in case none are present at the location of the accident already. The resulting event data may also be used to notify other autonomous vehicles driving towards the scene of the accident and to possibly alter their route, if time permits.

A majority of event data that is generated by or related to the operation of a supply chain asset utilized during the execution of supply chain processes may occur in the field of transportation, logistics, material movement or manufacturing. However, the present invention is not limited to the field of supply chain management alone and may apply equally to other fields in which events occur and event data may be generated including, but not limited to, warehouse operations, cross-dock operations, manufacturing and assembly operations, pick, pack and ship operations, quality inspection operations, testing or lab operations, retail operations, operations concerned with movement of human beings or personnel, agricultural operations, construction operations, refinery operations, mining and drilling operations, hospital operations, restaurant operations, food truck operations, catering operations, hotel operations, cruise ship operations, hospitality operations, theme park operations, airport operations, seaport operations, rail yard operations, switching yard operations, train station operations, subway station operations, bus terminal operations, waste management operations, maintenance or repair operations, installation operations, passenger travel operations, defense and military operations, law enforcement operations, document management operations, public or private event operations, concert operations, sporting event operations, motor or animal racing operations, museum operations, or pop-up store operations.

Operations during which event data is captured include, but are not limited to, private, non-profit, commercial, government, non-government organization or military operations. Event data may be captured during the use of supply chain assets such as vehicles or material handling equipment which may include, but are not limited to, heavy trucks, light trucks, trailers, tankers, self-driving trailers, containers, self-driving containers, tanker trucks, delivery vans, step vans, maintenance vans, repair vans, installation vans, pickup trucks, tractors, agricultural vehicles, agricultural machines, lawn mowers, golf carts, container moving equipment, trailer moving equipment, robotic movers, cranes, construction equipment, drilling and mining equipment, oil and gas exploration equipment, forklifts, pallet jacks, robotic storage shelves, material pickers, busses, locomotives, rail cars, switching engines, specialty railroad equipment, passenger trains, commuter trains, subway trains, law enforcement vehicles, fire trucks, ambulances, first responder vehicles, passenger vehicles, taxis, ride sharing vehicles, airplanes, helicopters, drones, airborne passenger transport vehicles, motorcycles, scooters, boards, bicycles, boats, barges, container ships, tanker ships, cruise ships, sail boats, yachts, ferries, catamarans, personnel moving ships, landing crafts, hovercrafts, tug boats, or speed boats.

Event data generated during the operation of a supply chain asset may be captured by means of a manual user entry or by means of an event data capture device or computer that can partially or fully capture event data automatically. Devices or computers that rely on either manual, automated, or partially manual and partially automated capture of event data include, but not limited to, a smart watch, a wearable device, a medical or biometric device, a sensor or actuator, an Internet of Things device, a phone, a pager or other wireless device, a barcode reader, a handheld RFID device, a stationary RFID device, an RTLS device, a BLE device, a GPS device, a lidar, a radar, a CPU, a GPU, a FPGA, a chip with an integrated circuit, an electronic logging device, a sensor, an actuator, a tablet computer, a desktop computer, a laptop computer, a data center computer, a data center server, an image capture device, a video capture device, a sound recording device, a device used for the operation of a supply chain asset, a device permanently attached to a supply chain asset, a device temporarily used during the operation of a supply chain asset, a device attached to a product or material, a device attached to a pallet or packaging, a device mounted to a building, a device positioned along a road, a public or private website, a public or private database, a device controlled by a third party, a computer controlled by a third-party, a computer controlled by a third party involved in or affected by the operation of a supply chain transaction, a satellite, a surveillance camera, or a drone.

A computer may be located locally or remotely including, but not limited to, in a data center or a computer cloud. Computers may communicate with one another through one of several means including, but not limited to, a connection using a wire or cable, a wireless connection using nearfield technologies, a wireless connection using cellular or satellite wireless networks, a wireless connection using proprietary wireless networks or a connection in which data is downloaded manually or automatically from one computer and then uploaded manually or automatically to another computer. In some embodiments of the present invention, the above devices or computers may only capture event data. In other embodiments of the present invention, a device or computer may format, process, analyze, share, or store event data as well.

Event data may be captured in formats including, but not limited to, textual, numerical, still image, video, graphical, abstracted, abbreviated, proprietary, or audible form. Event data may be obtained by way of collection mechanisms including, but not limited to, means employed by any device or computer listed above, manual or automated user entry or selection, automated software entry or selection, third-party systems by way of an interface, direct or indirect measurement, a trigger by another computer, or observation. Event data may further be obtained through means including, but not limited to, data previously stored on any device or computer listed above, data previously stored on any computer described in the present invention disclosure, manual or previously stored data entered by users, manual or previously stored user selections, rule-based or otherwise automated software inputs, data from artificial intelligence computers, data from other computers used in the capture of events, data from computers comprising a distributed ledger, data from publicly available sources, data from private sources, or data from documents including, but not limited to, instructions for handling of a business process, instructions for handling of materials, instructions for operating an asset, instructions for operating a machine, user manuals, certificates, warranties, or other documents related to the operation and execution of a supply chain process. Examples of events and event data are listed further below.

In some embodiments of the present invention, events may be captured by devices or computers that are temporarily attached to a semi-autonomous or autonomous vehicle or a material. Examples of temporary devices or computers may include, but are not limited to, wireless sensors to measure conditions such as shock, acceleration, deceleration, temperature, humidity or physical location. Other temporary devices may include, but are not limited to, RFID tag readers, barcode readers, BLE devices or other wireless devices that allow for the identification of items through the scan of a barcode or electronic tag. A temporary device or computer may be attached to materials being transported, to packaging materials, or to a supply chain asset. A temporary device or computer may communicate with any other computer described in the present invention in a multitude of ways including, but not limited to, wirelessly, through a cable, or through other mechanisms to upload or download event data. Temporary devices may be used frequently in some embodiments of the present invention, especially when autonomous vehicles may be used for a multitude of purposes or for a multitude of people or freight movements. The data generated by temporary devices may be available immediately, or it may only become available after a period of time has passed.

In some embodiments of the present invention, event data may be captured and processed by external systems that are not directly controlled by parties who are directly involved in a supply chain process or transaction including, but not limited to, a security camera, a warehouse camera, a camera mounted on a material moving asset such as a pallet jack or forklift, a camera mounted on another vehicle or another supply chain asset, an RFID reader, or a variety of sensors. For example, a camera mounted to the outside of the loading dock of an adjacent facility to a pick-up location may capture the license plate of a supply chain asset to identify the supply chain asset and then send an alert to the system described in the present invention so that all parties involved in the transaction may be notified that the supply chain asset has arrived at the pick-up location loading dock.

Events that occur during a supply chain transaction utilizing a supply chain asset and the resulting event data include, but are not limited to, a date, a time, a physical location, a supply chain asset identifier, a supply chain asset owner identifier, a supply chain asset operator identifier, a device identifier, a computer identifier, a material identifier, a freight identifier, a warehouse identifier, a cross-dock identifier, a yard identifier, a storage location identifier, a facility identifier, a manufacturing plant identifier, a depot identifier, a retail location identifier, a home base identifier, a repair location identifier, a plan or planning identifier, a user name or user identifier, a password, a temporary password, a cryptographic public key, a cryptographic private key, a hash, a third-party operator identifier, a location identifier, a customer identifier, a retailer identifier, a wholesaler identifier, a distributer identifier, a shipper identifier, a carrier identifier, a case identifier, a process identifier, an origin location identifier, a midway point identifier, a destination identifier, a route identifier, a tracking identifier, an identifier designated by a third-party system, a traffic condition, a road condition, a road hazard, road construction, a type of road, a light condition, an atmospheric condition, a facility condition, a location of a supply chain asset, an origin location, a destination location, a location along a route, an alert about an exception condition, a travel time, a dwell time, a delay, an accident, an estimated departure time, an estimated arrival time, a loading capacity, weight of loaded freight on a supply chain asset, a hazardous material classification, instructions for handling of a hazardous material, a weather condition, a temperature condition, a barometric condition, measurement of a shock, measurement of an impact, an operating condition, a breakdown, a need for repair, a need for maintenance, an application of brakes, an application of acceleration, an obstacle, a breakdown in wireless communication, establishment of wireless communication, one or more results of actions taken by an operator, establishment of a route, a change in a route, a sensor reading, an image capture, a satellite image, a video, a purchase order, a sales order, a transportation order, a shipping order, a packing list, a bill of materials, a delivery note, a waybill, an air waybill, a bill of lading, a CMR document, a multimodal bill of lading, a cargo insurance certificate, a commercial invoice, an international commercial invoice, an international proforma invoice, an international purchase order, a general conditions of international sale document, an ATA carnet, a carnet, a certificate of origin, a certificate of inspection, a certificate of analysis, a phytosanitary document, a kosher certificate, a halal certificate, a manifest, a transport order, presence of a material, absence of a material, presence of an operator or passenger, absence of an operator or passenger, a change in freight, absence of a change in freight, a payment receipt, absence of a payment receipt, loading of freight, time to load freight, securing of freight, capture of an image of freight, dwell time at a warehouse or dock, charges for excessive dwell time at a warehouse or dock, staging of freight prior to loading, absence of freight staging prior to loading, availability of human operators during loading, a freight condition at origin, presence of freight securing devices at origin, absence of freight securing devices at origin, handling instructions for freight securing, freight pickup completion, a freight condition at points along a route, duration of a transport transaction, a delay in freight delivery, damages to freight during shipment, proximity to a destination, distance from a destination, time to reach a destination, sequence of multi-stop deliveries, closeness of multi-stop delivery points, freight shipment completion, freight condition at destination, dwell time at destination, unloading of freight, time to unload freight at a destination, condition of freight securing devices at destination, freight drop-off completion, a freight theft, a freight damage, availability of human operators during unloading, results of quality inspections, time to return to an origin location, time to return to a home base location, time to a second pick-up location, distance to a second pick-up location, time to a second drop-off location, distance to a second drop-off location, condition of a manufacturing asset, condition of a freight moving or supply chain asset, an inventory identifier, an inventory location identifier, availability of a material in inventory, an inventory location, an inventory dwell time, a container location, a container dwell time, a trailer location, a trailer dwell time, a FIFO sequence, a LIFO sequence, a restocking sequence, a restocking signal or alert, a quality inspection result, a quality inspection trigger, a staging location, a staging process completion signal, a staging process incomplete signal, a human operator availability during freight staging, a process operator identifier, operator certifications and permits, supply chain asset permits, a hazardous material permit, a hazardous material certification for an operator, material inventory on a supply chain asset, tool availability on a supply chain asset, parts or tools inventory at an installation or maintenance location, proximity to an installation or maintenance point, distance from an installation or maintenance location, time to reach an installation or maintenance location, time to return to a depot or base location, sequence of multi-stop installation or maintenance operations, dwell time at an installation or maintenance location, closeness of multi-stop installation or maintenance locations, a physical storage location of materials, a condition of a manufacturing asset, demand for materials in specific markets and geographies, availability of materials in geographic locations, price of a material, public holidays, employee vacation, employee sickness, employee absence, employee licenses and certifications, employee health status, a certificate to operate supply chain asset, a drivers license, financial payments, receipts of financial payments, terms of payment, payment delays, immediate payments, discounts and bonuses, motivational incentives, points to complete a process, transaction, activity or task, availability of other contractual agreements, a fuel condition, an energy condition, availability of fuel or energy, location of a refueling or charging point, a regulatory mandate, a law or ordinance, completion of a process, non-completion of a process, availability of documents relevant to the operation of a supply chain transaction, availability of computers storing documents relevant to the operation of a supply chain transaction, or availability of human or machine operators monitoring the operation of a supply chain transaction. Some events and event data are the result of processes performed by supply chain assets or operators engaged during the operation and execution of a supply chain transaction while other events and event data are external occurrences and out of the control of a human or machine operator, a business or a third party. The absence of an event completion including, but not limited to, unfinished data inputs, disrupted data inputs, incorrect data inputs, or missing data inputs may be considered event data in its own right for the purposes of the present invention disclosure.

The capture, monitoring, documentation and sharing of event data generated during the operation of a supply chain asset is an important part of the present invention. When exceptions from expected values of event data occur, any computer shown in the present invention disclosure may create and send an alert about an exception condition to any other computer or to users of external computers. Exception alerts may be treated as event data for the purposes of the present invention disclosure and they may be written to a distributed ledger in the same way as any other event data. Further applying the principle, when any computer shown in the present invention disclosure determines that a different course of action from an initial course of action may be necessary, it may create and send an alert about a change in the course of action to any other computer or to users of external computers. Alerts on a change in a course of action may be treated as event data for the purposes of the present invention disclosure and they may be written to a distributed ledger in the same way as any other event data.

Materials or freight may include, but are not limited to, raw materials, parts, consumables, work-in-progress materials, manufacturing assets, packaging, freight securing devices, pallets or crates, containers, written documents such as manuals or instructions, or finished goods or products. Materials may have a physical form generally as a gas, liquid or solid or they may not have a physical form including, but not limited to software or data.

Supply chain assets and devices that capture, format and process event data may be used in a variety of supply chain operations. A supply chain operation is a process, or transaction, which comprises a series of activities or tasks comprising of people, machines, materials, skills, and knowledge to achieve an aim or objective. For the purposes of the present invention disclosure, we refer to a process as a class of transactions, for example “loading of freight” or “unloading of freight,” and to transactions as an instance of a process, for example the “loading of freight on a given day in a specific location”. A process may comprise of many transactions and many transactions may all be instances of a single process. Supply chain processes or transactions generate events and event data or are affected by events and event data. For example, the outcome of a process, transaction, activity or task is one or more event or event data often, an event resulting from activities performed in one process or transaction serves as a basis for how activities in another process or transaction are performed. A simple example may be that when a material pickup by a truck is delayed at the material origin, the likelihood of a delay in the material delivery at a destination increases greatly.

A business process may comprise a multitude of events that may occur in a sequence or in parallel. Events comprise of the occurrence of a state and are documented through event data. When an event occurs, the resulting event data is captured by one or more devices or computers. An important aspect of how a business process and an event are related to one another is that a business process typically begins with an event and ends with an event. For example, a shipper may have freight that needs to be moved. The shipper will determine a route, a day and time, availability of a supply chain asset, etc. in order to begin the process of transporting the freight. The initial steps of setting up a plan are considered a course of action within the present invention disclosure. The first event and resulting event data in this process may be to set a course of action including, but not limited to, determining a pickup time, determining a drop off time, determining a transit time, determining a loading time, identifying special handling instructions, and so on. This course of action is then communicated to other participants in the transaction so that they can plan how to operate later business processes. At different stages during the operation of a supply chain process, events and event data may be used to monitor whether the course of action is still attainable or whether a change in the course of action is necessary. Delays of a supply chain asset for example due to problems in loading, traffic or extreme weather conditions, delays during unloading, etc. may lead to a change in the initial course of action.

A supply chain is a series of processes comprising of people, machines, materials, skills, and knowledge that transform one or more raw materials into one or more finished products. For example, supply chain processes include, but are not limited to, inbound transportation of materials, manufacturing, warehousing, outbound shipping, placement of product in customer locations, maintenance sites or installation sites, maintenance of materials after installation and also the return of products from customers back to retailers, distributors, wholesalers, or manufacturers. Further examples of supply chain processes include, but are not limited to, loading of materials onto supply chain assets, storing of materials, counting and inspecting materials, counting materials in storage, quality inspections, repair or replacement of defective materials, replenishment of missing materials, exchange of older materials for newer ones, taking of materials out of storage, audits, collection of metrics regarding cost, time, quality, quantity or other attributes of processes or materials, planning of manufacturing processes, marketing and sales promotions, advertising, sponsorship or social media campaigns, employee training and education, labor disputes or strikes, or unloading of materials at a destination.

In some embodiments of the present invention, the operation and execution of a supply chain process documented through the capture, processing, formatting, analysis, monitoring, decision-making, sharing, or storing of event data may yield metrics describing the performance of a supply chain asset, an operator, a party directly involved in the operation and execution of a supply chain process, a party not directly involved in the operation and execution of a supply chain process, or other aspects of the supply chain process itself metrics may serve as a basis for operational decision-making by human or machine operators of any of the computers described in the present invention metrics may be displayed to human or machine operators by formats including, but not limited to, textual, numerical, abstracted, abbreviated, compressed, or graphical form. Examples of metrics include, but are not limited to, operator work hours, drive times, dwell times, supply chain asset utilization, warehouse efficiency, depot efficiency, retail location efficiency, fuel efficiency, route efficiency, travel time, toll charges, fee charges, insurance premiums, accident conditions, insurance payments, freight per customer metrics, freight per mile metrics, cost per mile metrics, weather influences on supply chain assets, efficiency by freight type, efficiency by trailer type, efficiency by process, efficiency by transport type, efficiency by distance to destination, efficiency in less-than-truckload operations, efficiency in last mile operations, efficiency in sea port deliveries and pickups, efficiency in airport deliveries and pickups, efficiency in parcel delivery, maintenance and repair efficiency, or the efficiency of a system to store event data on a distributed ledger. Any computer discussed in the present invention disclosure may collect, process, share or use metrics as described above.

In some embodiments of the present invention external data sources are used to obtain data that adds meaning during the interpretation and analysis of event data. External data sources may include, but are not limited to, an enterprise resource planning system, a customer data system, a supplier system, a business partner system, a transportation management system, a route management system, a freight forwarding system, a freight brokerage system, a warehouse management system, a global trade management system, a financial system, a banking system, a credit card processing system, an online sales system, a sales support system, a customer relationship management system, a supplier relationship management system, a human resource management system, a time and attendance system, an online database, a system containing publicly available data, a system containing private data, a system containing military data, or a system containing government data.

In some embodiments of the present invention, a supply chain asset may operate fully autonomously, partially autonomously or fully manually with a human operator one or more autonomous supply chain assets may be locally or remotely monitored by a human or machine operator.

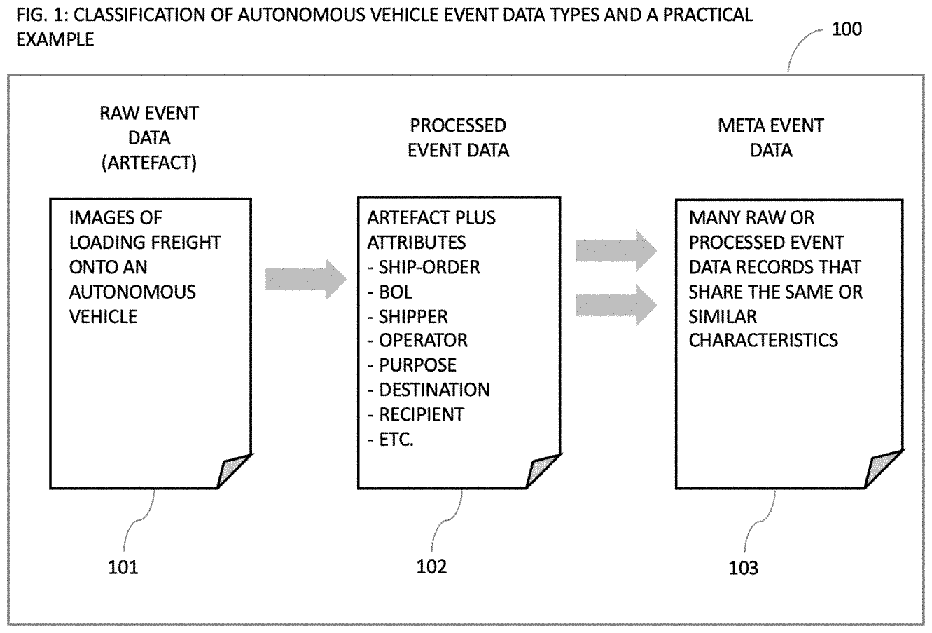

Referring to FIG. 1, event data may be described by one of three types. Classification 100 comprises three types of event data and a practical example. Raw event data (101) is captured by a device or computer and enhanced through attributes, which may be raw event data in their own right, to provide additional context, into processed event data (102) while either raw or processed event data may be aggregated into meta event data (103) for the purposes of analysis and deeper understanding. For example, when a camera on an autonomous vehicle takes a photo of freight on a trailer, the photo itself is raw event data. When it is sent to a computer that needs to process the photo, it is therefore necessary to add additional attributes such as on which autonomous vehicle the photo was taken (vehicle ID), on which date and at which time it was taken, etc in order to understand the meaning of the image. A computer that processes event data can make sense of it by obtaining details about a supply chain process to know where the autonomous vehicle was, whose freight it was carrying and so on. All of the information that is added to the original photo is considered attributes for the purposes of the present invention. When raw data and attributes are combined to establish meaningful event data, the resulting data is processed event data.

In some embodiments of the present invention, event data may remain in its raw form and may not be processed further before being sent from or to any computer described in the present invention disclosure.

In some embodiments of the present invention, raw event data (101) and attributes may be obtained from a computer not directly used in the operation and execution of a supply chain process. Some sources of raw event data (101), for example when it originates from computers operated by parties including, but not limited to, shippers, forwarders, brokers, third-part logistics providers, or carriers, may send more than one raw event data (101) element in a computer file. An example of a computer file or document that may contain more than one raw event data (101) element is a bill of lading (BOL), which may be comprised of data about a shipper, data about one or more materials being transported, specific instructions for transport handling, or data about the destination or recipient of the materials.

When raw event data (101) is captured by a device, it may not always provide enough information to enable decision-making about maintaining or changing a course of action. For example, the capture of location coordinates for a supply chain asset is not sufficient to draw meaningful conclusions about its current situation or the supply chain assets' ability to deliver the freight on time. Location coordinates provide a latitude and longitude, time stamp and speed. It is only when further attributes in the form of additional raw event data (101) are applied that the resulting processed event data (102) becomes valuable. In the example, useful attributes include a distance to the destination, an estimated arrival time, typical traffic and road conditions on the route ahead or work hour restrictions of operators involved during the execution of a supply chain process.

Another example may be the observation of a loading process to load materials onto a trailer of a supply chain asset by means of a camera mounted in the loading space of a trailer or inside of a warehouse facility. The resulting images of the loading process capture observations of raw events (101), which includes information about how many pallets or packages have been loaded, whether the freight was properly secured, or that pallets were not double-stacked when this is not desirable. However, the image file itself, which is raw event data (101) is still of little value until it is combined with attributes that describe the supply chain asset itself, its current process and purpose, its current location, a shipping order, a bill of lading, data bout the shipper of the freight, a local or remote operator of a semi-autonomous or autonomous vehicle, etc. The addition of attributes to the raw event data (101) captured by a camera transforms it into processed event data (102), which in this example allows local or remote human or machine operators to verify that the loading operation has been completed successfully or, conversely, that it has not been handled properly.

Another practical example may be that an autonomous vehicle is engaged in a shipment of materials from one city to another where the materials are expected 12 hours after departure from an origin location. Every time a location based on GPS coordinates is recorded for the autonomous vehicle, the systems described herein may then calculate whether the autonomous vehicle is still on time to meet the delivery deadline and may issue an alert when the autonomous vehicle is no longer able to arrive on time. In this example, a raw event (101) consisting of latitude and longitude has been transformed into a processed event (102) through the application of attributes such as the distance from destination, travel speed and local traffic.

As described, an important aspect of managing events in supply chain processes is that raw event data (101) often needs to be enriched through one or more attribute, providing additional data, before it becomes valuable to users. Raw event data (101) may be enriched through the addition of attributes, which may be raw event data in its own right or other data relevant to the operation and execution of supply chain processes, into processed event data (102). Processed event data (102) may contain one or more raw event data element and one or more attribute. Attributes allow for the transformation of raw event data (101) into processed event data (102) and may come from a multitude of computers including, but not limited to, previously stored raw event data (101), previously stored processed event data (102), previously stored meta event data (103), data already residing on the computer that handles the transformation of raw event data (101) into processed event data (102), another instance of a computer capturing raw event data (101), another instance of a computer transforming raw event data (101) into processed event data (102), any computer discussed in this invention disclosure, or they may come from a variety of external data sources discussed in this invention disclosure.

A multitude of raw or processed event data elements that have the same or similar characteristics may be combined into meta event data (103), which describes commonalities or patterns that may exist within a multitude of raw or processed event data elements. Meta event data allows the identification of similarities or differences within a multitude of raw or processed event data elements as well as the identification of patterns, especially when raw event data and attributes are compared in processed event data. In some embodiments of the present invention, event data that may not have the same or similar characteristics may also be combined into meta event data (103) to gain a deeper understanding.

A practical example of processing a multitude of raw event data (101) or processed event data (102) into one or more meta event data (103) elements may be that a multitude of supply chain assets might undertake a transport from point A to point B passing through a multitude of traffic situations. In this example, it is conceivable that the travel times between points A and B ranged from two hours to four hours. By analyzing a multitude of processed event data (102) each describing specific instances of the travel from A to B, it may be possible to deduce that travel times are shorter on certain days and longer on others, that specific start times led to faster travel than others or that local sporting events or local temperatures had an effect on travel time. In this example, the resulting meta event data (103) may outline all of these factors or specific recommendations to allow local or remote human or machine operators to determine on which days and at which times they might operate a supply chain asset for the movement of freight or passengers. Another practical example may be that several supply chain assets may have picked up a specific type of material as freight from a multitude of manufacturers of the material. By comparing and analyzing dwell times at a loading dock in each specific instance, it may be possible to deduce average loading times by manufacturer, which in turn may be used for the calculation of overall process times from the pickup to the delivery of freight for future supply chain asset operations.

In one embodiment of the present invention, events may be captured and processed by external systems that are controlled by parties who do not own or operate an autonomous vehicle involved in a transaction including, but not limited to, a security camera, a warehouse camera, a camera mounted on a material moving asset such as a pallet jack or forklift, an RFID reader, or a variety of sensors. For example, a camera mounted to the outside of a loading dock door may capture the license plate of a trailer or of an autonomous vehicle to identify the particular supply chain asset and then send an alert to all parties involved in the transaction that the autonomous vehicle has arrived at the loading dock. While the alert may be a processed event (102) for the originating system, it serves as a raw event (101) and one or more attributes for the computing systems described in the present invention.

In another embodiment of the present invention, events may be captured by temporary devices such as a wireless sensor to measure conditions including, but not limited to, shock, acceleration, deceleration, temperature or humidity. A temporary device may be attached to materials being transported, may be attached to packaging materials, or may be temporarily attached to an autonomous vehicle. A temporary device may communicate with a computing system to capture events in a multitude of ways including, but not limited to, wirelessly, through a cable, or through other mechanisms to upload or download event data. Temporary devices may be used frequently in some embodiments of the present invention, especially when autonomous vehicles may be used for a multitude of purposes or for a multitude of people or freight movements. The event data generated by temporary devices may be available immediately, or it may only become available after a period of time has passed.

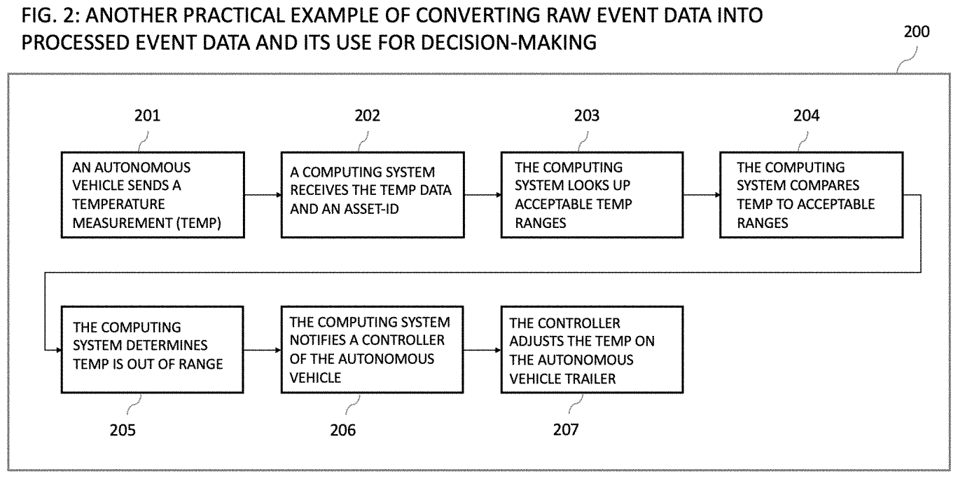

Referring to FIG. 2, a block diagram with practical example comprising a flow for the conversion of raw data into processed data is shown. Diagram 200 comprises of seven steps to obtain raw event data (101) and additional attributes to create a processed event (102) based on the addition of attributes and performance of an analysis. A supply chain asset that carries temperature sensitive materials on a refrigerated trailer for example may be equipped with a temperature sensor that sends regular updates to a computer system so that they can be analyzed (201). The computer system receives the temperature measurement and also a supply chain asset identification number, which constitutes raw event data (202). Based on the supply chain asset identification, the computer can locate a document that contains information about acceptable temperature ranges in its storage, which is raw event data (101) as well and serves as an attribute for the purposes of processing and analysis (203). The computer compares the temperature measurement, for example 43 F, to a range of acceptable values, for example 36-41 F (204). The result of the analysis is processed event data (102), which, in this example, enables an analysis and means that the materials are not being transported within an acceptable temperature range (205). Based on using raw event data (101) to derive processed event data (102), the computer sends the results of the analysis to a local or remote controller of the supply chain asset (206) to affect a course of action. The supply chain asset controller can locally or remotely adjust the temperature of the trailer to bring it back into the acceptable range (207).

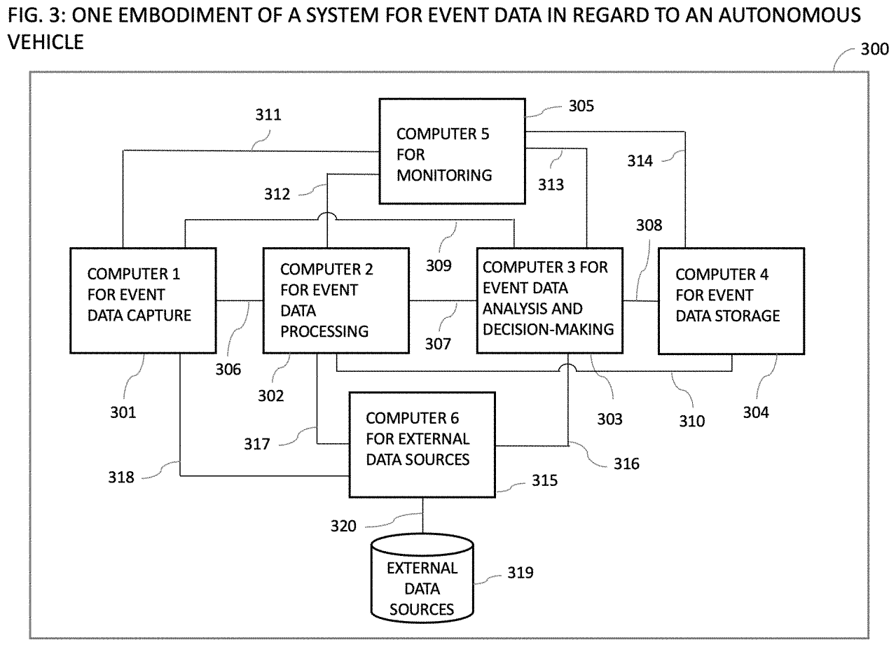

Referring to FIG. 3, one embodiment of the present invention for a system event data handling utilizing an autonomous vehicle is shown. System 300 comprises of six computers used in the capture, formatting, processing, analysis, monitoring, decision-making, sharing and storing of event data. Event data may be captured on a first computer (301), then being sent to a second computer (302) for processing, then being sent to a third computer (303) for analysis and decision-making, then being sent to a fourth computer (304) for storage, then being sent to a fifth computer (305) for monitoring other computers, and in some embodiments of the present invention for display to operators or controllers who may input decisions, and a sixth computer (315) to access data on external systems (319). Data residing on an external data source (319) may include, but is not limited to, raw event data (101), processed event data (102) or meta event data (103), one or more attributes, or other data relevant to the operation and execution of a supply chain process utilizing an autonomous vehicle. System 300 comprises of six computers that all receive and send data to one another about the operation and execution of a supply chain process utilizing an autonomous vehicle.

Sharing of event data between two or more of the computers in system 300 occurs by means of communication. Data formats used in communication may include, but are not limited to, native, proprietary, textual, numerical, image, video, audio, abbreviation, abstraction, compression, hash, or encrypted form. Event data may be sent from one computer to any other computer in the format in which it was captured or received, or in a different format from the one in which it was captured or received. Communication between two or more computers in System 300 may be unsecured or secured. Secured communication may include, but is not limited to, the use of authentication of users prior to the display of event data, the use of encryption of event data or documents during sending and receiving, the use of private and public keys, the use of secure socket layers, or the use of a virtual private network. User authentication mechanisms may include, but are not limited to, a user name, a password, a fingerprint, a retina scan, a facial image recognition, a voice recognition, a user location, a DNA marker, other biometric factors such as gait, other hardware devices, or any combination thereof. For example, the use of private and public keys allows for the authentication of users who create and share event data or documents in that only one party possesses a private key and can encrypt event data with it while a multitude of parties may be able to decrypt the event data using a freely available corresponding public key. In some embodiments of the present invention, public keys may be stored on a distributed ledger.

In one embodiment of the present invention, any computer shown in system 300 may handle raw event data (101), processed event data (102), meta event data (103), one or more results of analysis, one or more decisions, one or more attributes, or other data relevant to the operation and execution of a supply chain process utilizing an autonomous vehicle in its original, whole form. In another embodiment of the present invention, any computer shown in system 300 may handle raw event data (101), processed event data (102), meta event data (103), one or more results of analysis, one or more decisions, one or more attributes, one or more hashes, or other data relevant to the operation and execution of a supply chain process utilizing an autonomous vehicle in abbreviated, abstracted, compressed, or encrypted form. In another embodiment of the present invention, any computer in System 300 may create and share a hash, using a hashing function, of raw event data (101), processed event data (102), meta event data (103), one or more results of analysis, one or more decisions, one or more attributes, one or more other hashes, or other data relevant to the operation and execution of a supply chain process utilizing an autonomous vehicle.

In some embodiments of the present invention, a second (302), third (303), fifth (305) or sixth (315) computer shown in system 300 may request and initiate the capture of raw event data (101), the creation of processed event data (102) or meta event data (103), the creation of a hash, the analysis of event data, the making of a decision, the monitoring of event data, the storage of event data, or the sharing of event data from other computers shown in system 300.

In some embodiments of the present invention, a second (302), third (303), fifth (305) or sixth (315) computer in System 300 may receive a request for a first computer to capture raw event data, which it then sends to a first computer (301), for execution of the request.

In some embodiments of the present invention, any computer in System 300 may store and maintain previous raw event data (101), previous processed event data (102), previous meta event data (103), previous attributes, results from a previous analysis, previous decisions, previous hashes, or previously received other data relevant to the operation and execution of a supply chain process utilizing a supply chain asset.

In some embodiments of the present invention, it may be necessary for any computer in System 300 to request additional raw event data (101), additional processed event data (102), additional meta event data (103), one or more additional attributes, one or more additional hashes, or other additional data relevant to the operation and execution of a supply chain process from other computers in System 300.

In some embodiments of the present invention, a third computer (303) in System 300 may serve as a basis for operational decision-making by generating, analyzing or using performance metrics as described above.

In some embodiments of the present invention, a fifth computer (305) in System 300 may display event data in graphical form, numerical or textual form, on a map, or as a performance metric to a user.

In some embodiments of the present invention, a second (302) or third (303) computer may request, capture, format, process, monitor, hash, share, or store event data that may not necessarily be required during the current operation of a supply chain process utilizing an autonomous vehicle.

In some embodiments of the present invention, a first computing system (201) may provide event data related to the supply chain asset itself or its operation including, but not limited to, determination of operator or controller work hours, autonomous vehicle utilization, autonomous vehicle efficiency, maintenance and repair dates, maintenance and repair activities, fuel efficiency, route efficiency, travel time, toll, fee and charge avoidance, insurance premiums, accident conditions, insurance payments, freight per customer metrics, freight per mile metrics, cost per mile metrics, weather influences on autonomous vehicle operations, efficiency by freight type, efficiency by trailer type, efficiency by process, efficiency by transport type, efficiency by distance to destination, efficiency in less-than-truckload operations, efficiency in last mile operations, efficiency in sea port deliveries and pickups, efficiency in airport deliveries and pickups, efficiency in parcel delivery, efficiency in letter and document delivery, or efficiency of an autonomous vehicle event management system.

A first computer (301) captures raw event data (101) and may store and retrieve processed event data (102), meta event data (103), one or more results of analysis, one or more decisions, one or more attributes, one or more hashes, or other data relevant to the operation and execution of a supply chain process utilizing an autonomous vehicle.

In one embodiment of the present invention, a first computer (301) may capture event data based on a precondition being met including, but not limited to, a process initiating, a process occurring, or a process completing. In another embodiment of the present invention, a first computer (301) may capture event data based on a user instruction or command, or a software trigger. In another embodiment of the present invention, a first computer (301) may capture event data based on an instruction received from another computer described in system 300. In another embodiment of the present invention, a first computer (301) may capture event data based on a pre-programmed condition including, but not limited to, a deviation from expected values or a deviation from a range of acceptable values. In another embodiment of the present invention, a first computer (301) may capture event data based on points in time, including, but not limited to, capturing of event data at regular intervals (i.e., every x minutes), at a given hour, or once, twice, thrice, etc. per day. In another embodiment of the present invention, a first computer (301) may be programmed to capture event data randomly. In another embodiment of the present invention, a first computer (301) may receive an instruction to capture event data from another instance of a first computer, from another instance of a second computer, from another instance of a third computer, from another instance of a fifth computer, or from another instance of a sixth computer to access external data.

A first computer (301) may capture raw event data (101) and send it to a second computer (302) by means of communication (306), to a third computer (303) by means of communication (309), a fifth computer (305) by means of communication (311), or a sixth computer (315) to access external data (319) by means of communication (318). Not shown in System 300, a first computer (301) may capture raw event data (101) and send it to another instance of a first computer, or directly to a fourth computer (304) by means of communication.

A first computer (301) may receive raw event data (101), processed event data (102), meta event data (103), one or more results of analysis, one or more decisions, one or more attributes, one or more hashes, or other data relevant to the operation and execution of a supply chain process from a second computer (302) by means of communication (306), to a third computer (303) by means of communication (309), a fifth computer (305) by means of communication (311), or a sixth computer (315) to access external data (319) by means of communication (318). Not shown in System 300, a first computer (301) may receive raw event data (101), processed event data (102), meta event data (103), one or more results of analysis, one or more decisions, one or more attributes, one or more hashes, or other data relevant to the operation and execution of a supply chain process utilizing an autonomous vehicle from another instance of a first computer, or a fourth computer (304) by means of communication.

A first computer (301) may send processed event data (102), meta event data (103), one or more results of analysis, one or more decisions, one or more attributes, one or more hashes, or other data relevant to the operation and execution of a supply chain process utilizing an autonomous vehicle to a second computer (302) by means of communication (306), to a third computer (303) by means of communication (309), a fifth computer (305) by means of communication (311), or a sixth computer (315) to access external data (319) by means of communication (318). Not shown in System 300, a first computer (301) may send processed event data (102), meta event data (103), one or more results of analysis, one or more decisions, one or more attributes, one or more hashes, or other data relevant to the operation and execution of a supply chain process utilizing an autonomous vehicle to another instance of a first computer, or a fourth computer (304) by means of communication.

A second computer (302) processes raw event data (101), previous raw event data, processed event data (102), previous processed event data, meta event data (103), previous meta event data, results from a previous analysis, previous decisions, one or more attributes, one or more hashes, or other data relevant to the operation and execution of a supply chain process utilizing an autonomous vehicle as described in Classification 100.

A second computer (302) may receive raw event data (101), processed event data (102), meta event data (103), one or more results of analysis, one or more decisions, one or more attributes, one or more hashes, or other data relevant to the operation and execution of a supply chain process utilizing an autonomous vehicle from a first computer (301) by means of communication (306), a third computer (303) by means of communication (307), a fourth computer (304) by means of communication (310), a fifth computer (305) by means of communication (312), or a sixth computer (315) to access external data by means of communication (317). Not shown in System 300, a second computer (302) may receive raw event data (101), processed event data (102), meta event data (103), one or more results of analysis, one or more decisions, one or more attributes, one or more hashes, or other data relevant to the operation and execution of a supply chain process utilizing an autonomous vehicle from another instance of a second computer by means of communication.

A second computer (302) may send raw event data (101), processed event data (102), meta event data (103), one or more results of analysis, one or more decisions, one or more attributes, one or more hashes, or other data relevant to the operation and execution of a supply chain process utilizing an autonomous vehicle to a first computer (301) by means of communication (306), a third computer (303) by means of communication (307), a fourth computer (304) by means of communication (310), a fifth computer (305) by means of communication (312), or a sixth computer (315) to access external data by means of communication (317). Not shown in System 300, a second computer (302) may send raw event data (101), processed event data (102), meta event data (103), one or more results of analysis, one or more decisions, one or more attributes, one or more hashes, or other data relevant to the operation and execution of a supply chain process utilizing an autonomous vehicle to another instance of a second computer by means of communication.

A third computer (303) analyzes raw event data (101), processed event data (102), meta event data (103), one or more attributes, previous results of analysis, previous decisions, one or more hashes, or other data relevant to the operation and execution of a supply chain process utilizing an autonomous vehicle in order to decide on a course of action comprising no change, postponement of a decision or a different course of action.

In one embodiment of the present invention, a third computer (303) may display the results of an analysis to a local or remote human or machine operator or controller to obtain a decision on a course of action comprising no change, postponement of a decision or a different course of action. In another embodiment of the present invention, a third computer (303) may send the results of an analysis to a fifth computer (305) by means of communication (313) in order for a fifth computer (305) to display the results of an analysis to a local or remote human or machine operator or controller who decides on a course of action comprising no change, postponement of a decision or a different course of action.

In another embodiment of the present invention, a third computer (303) may send the results of an analysis to a sixth computer (315) to access external data by means of communication (316) in order for a sixth computer (315) to display the results of an analysis to a local or remote human or machine operator or controller of an external system who decides on a course of action comprising no change, postponement of a decision or a different course of action. An external system may then send the decision to a sixth computer (315) by means of communication (316), which in turn may send it to other computers in System 300.

A third computer (303) may receive raw event data (101), processed event data (102), meta event data (103), one or more results of analysis, one or more decisions, one or more attributes, one or more hashes, or other data relevant to the operation and execution of a supply chain process utilizing an autonomous vehicle from a first computer (301) by means of communication (309), a second computer (302) by means of communication (307), a fourth computer (304) by means of communication (308), a fifth computer (305) by means of communication (313), or a sixth computer (315) to access external data (319) by means of communication (316). Not shown in System 300, a third computer (303) may receive raw event data (101), processed event data (102), meta event data (103), one or more results of analysis, one or more decisions, one or more attributes, one or more hashes, or other data relevant to the operation and execution of a supply chain process from another instance of a third computer by means of communication.

A third computer (302) may send raw event data (101), processed event data (102), meta event data (103), one or more results of analysis, one or more decisions, one or more attributes, one or more hashes, or other data relevant to the operation and execution of a supply chain process utilizing an autonomous vehicle to a first computer (301) by means of communication (309), a second computer (302) by means of communication (307), a fourth computer (304) by means of communication (308), a fifth computer (305) by means of communication (313), or a sixth computer (315) to access external data (319) by means of communication (316). Not shown in System 300, a third computer (303) may send raw event data (101), processed event data (102), meta event data (103), one or more results of analysis, one or more decisions, one or more attributes, one or more hashes, or other data relevant to the operation and execution of a supply chain process to another instance of a third computer by means of communication.

A fourth computer (304) may store raw event data (101), processed event data (102), meta event data (103), one or more attributes, one or more results of analysis, one or more decisions, one or more hashes, or other data relevant to the operation and execution of a supply chain process utilizing an autonomous vehicle. A fourth computer (304) may serve as a repository for previous data comprising of previous raw event data, previous processed event data, previous meta event data, previous attributes, previous results of analysis, previous decisions, previous hashes, or previously received other data relevant to the operation and execution of a supply chain process utilizing an autonomous vehicle.

In some embodiments of the present invention, a fourth computer (304) may store raw event data (101), processed event data (102), meta event data (103), one or more attributes, one or more results of analysis, one or more decisions, one or more hashes, or other data relevant to the operation and execution of a supply chain process utilizing an autonomous vehicle on more than one instance of a fourth computer. In some embodiments of the present invention, a fourth computer (304) may store raw event data (101), processed event data (102), meta event data (103), one or more attributes, one or more results of analysis, one or more decisions, one or more hashes, or other data relevant to the operation and execution of a supply chain process utilizing an autonomous vehicle partially on a first instance of a fourth computer, partially on a second instance of a fourth computer, partially on a third instance of a fourth computer, and so on.

A fourth computer (304) may receive raw event data (101), processed event data (102), meta event data (103), one or more results of analysis, one or more decisions, one or more attributes, one or more hashes, or other data relevant to the operation and execution of a supply chain process from a second computer (302) by means of communication (310), a third computer (303) by means of communication (309), or a fifth computer (305) by means of communication (314). Not shown in System 300, a fourth computer (304) may receive raw event data (101), processed event data (102), meta event data (103), one or more results of analysis, one or more decisions, one or more attributes, one or more hashes, or other data relevant to the operation and execution of a supply chain process from a first computer (301), another instance of a fourth computer, or a sixth computer (315) to access external data (319) by means of communication.

A fourth computer (304) may send raw event data (101), processed event data (102), meta event data (103), one or more results of analysis, one or more decisions, one or more attributes, one or more hashes, or other data relevant to the operation and execution of a supply chain process utilizing an autonomous vehicle to a second computer (302) by means of communication (310), a third computer (303) by means of communication (308), or a fifth computer (305) by means of communication (314). Not shown in System 300, a fourth computer (304) may send raw event data (101), processed event data (102), meta event data (103), one or more results of analysis, one or more decisions, one or more attributes, one or more hashes, or other data relevant to the operation and execution of a supply chain process utilizing an autonomous vehicle to a first computer (301), another instance of a fourth computer, or a sixth computer (315) to access external data (319) by means of communication.

A fifth computer (305) monitors the operation and execution of a supply chain process and displays information to local or remote machine or human operators or controllers to assess the operation and, in some embodiments of the present invention, affect a course of action before, during or after the operation and execution of a supply chain process utilizing an autonomous vehicle.

In some embodiments of the present invention, a fifth computer (305) may receive the results of an analysis from a third computer (303) or any other data from other computers shown in System 300 in order to affect a course of action. Once a local or remote human or machine operator or controller of a fifth computer (305) has determined a course of action comprising no change, postponement of a decision or a different course of action, a fifth computer (305) may allow the operator or controller to enter the resulting decision so that it may be sent to other computers shown in system 300. In some embodiments of the present invention, a fifth computer (305), operated by a local or remote human or machine operator or controller, may receive results of an analysis or a decision from a third computer (303) in order to explicitly validate or explicitly confirm a proposed course of action comprising no change, postponement of a decision or a different course of action. One example may be that when an autonomous vehicle in a given location senses heavy rain, freezing temperatures, or a snow storm, its estimated time of arrival may change. Further, the estimated time of arrival of other human operated, semi-autonomous or autonomous vehicles that may pass through the same location shortly or soon may be changed to a later estimated time of arrival due to the anticipated slower travel speeds necessitated by severe weather conditions. Another practical example may be that a change in temperature outside of an acceptable range on a temperature-controlled trailer may lead to a request to stop an autonomous vehicle until a defective temperature control system can be repaired. In some embodiments of the present invention, a fifth computer (305), operated by a local or remote human or machine operator, may receive results of an analysis or a decision from a third computer (303) or data from other computers shown in System 300 in order to implicitly validate or implicitly confirm a proposed course of action by not taking an action that opposes or negates the proposed course of action comprising no change, postponement of a decision or a different course of action.

In some embodiments of the present invention, a local or remote human or machine operator or controller using a fifth computer (305) may have the ability to manually enter a course of action comprising no change, postponement of a decision or a different course of action. In one embodiment of the present invention, a local or remote human or machine operator or controller may monitor a single instance of the operation and execution of a supply chain process. In another embodiment of the present invention, a local or remote human or machine operator or controller may monitor a multitude of instances of supply chain processes during their operation and execution. In some embodiments of the present invention, a fifth computer (305) may display data acquired before, during, or after the monitoring of a multitude of operations on a map, in the form of metrics, or any other way allowing a local or remote human or machine operator to control the operation of a multitude of supply chain assets in parallel. In some embodiments of the present invention, a fifth computer (305) may display raw event data (101), processed event data (102), meta event data (103), one or more attributes, one or more results of analysis, one or more decisions, one or more hashes, or other data relevant to the operation and execution of a supply chain process utilizing an autonomous vehicle on more than one instance of a fifth computer. In some embodiments of the present invention, a fifth computer (305) may display raw event data (101), processed event data (102), meta event data (103), one or more attributes, one or more results of analysis, one or more decisions, one or more hashes, or other data relevant to the operation and execution of a supply chain process utilizing an autonomous vehicle partially on a first instance of a fifth computer, partially on a second instance of a fifth computer, partially on a third instance of a fifth computer, and so on.

A fifth computer (305) may receive raw event data (101), processed event data (102), meta event data (103), one or more results of analysis, one or more decisions, one or more attributes, one or more hashes, or other data relevant to the operation and execution of a supply chain process utilizing an autonomous vehicle from a first computer (301) by means of communication (311), a second computer (302) by means of communication (312), a third computer (303) by means of communication (313), or a fourth computer (304) by means of communication (314). Not shown in System 300, a fifth computer (305) may receive raw event data (101), processed event data (102), meta event data (103), one or more results of analysis, one or more decisions, one or more attributes, one or more hashes, or other data relevant to the operation and execution of a supply chain process utilizing an autonomous vehicle from another instance of a fifth computer, or a sixth computer (315) to access external data (319) by means of communication.

A fifth computer (305) may send raw event data (101), processed event data (102), meta event data (103), one or more results of analysis, one or more decisions, one or more attributes, one or more hashes, or other data relevant to the operation and execution of a supply chain process utilizing an autonomous vehicle to a first computer (301) by means of communication (311), a second computer (302) by means of communication (312), a third computer (303) by means of communication (313), or a fourth computer (304) by means of communication (314). Not shown in System 300, a fifth computer (305) may send raw event data (101), processed event data (102), meta event data (103), one or more results of analysis, one or more decisions, one or more attributes, one or more hashes, or other data relevant to the operation and execution of a supply chain process utilizing an autonomous vehicle to another instance of a fifth computer, or a sixth computer (315) to access external data (319) by means of communication.

A sixth computer (315) provides access to external data that may not have been captured by a first computer (301) or obtained from a second computer (302), a third computer (303), a fourth computer (304), a fifth computer (305), or another instance of a sixth computer. A sixth computer (315) allows access to external data sources, examples of which are listed above.

In one embodiment of the present invention, a seventh computer (315) may obtain data from external data sources using automated computer system interface mechanisms including, but not limited to, an EDI document, an application programming interface, an application binary interface, a file grabber, direct access to an external computer, or direct access to an external computer database. In another embodiment of the present invention, a user of a seventh computer (315) may manually enter data obtained from an external computer by mechanisms that include, but are not limited to, looking at an external system, receiving data in an email or similar message, receiving a data file on a storage device, or receiving data via communication with a user of an external computer. In one embodiment of the present invention, a seventh computer (315) may only send event data to an external system. In another embodiment of the present invention, a seventh computer (315) may only receive event data from an external system. In another embodiment of the present invention, a seventh computer (315) may send event data to and receive event data from an external system. In another embodiment of the present invention, a seventh computer (315) may obtain data from an external computer comprising a distributed ledger. In some embodiments of the present invention, a local or remote human or machine operator of an external data source may receive a request for a decision from a seventh computer (315) and may send a decision on a course of action comprising no change, postponement of a decision or a different course of action to a seventh computer (315).

A sixth computer (315) to access external data may receive raw event data (101), processed event data (102), meta event data (103), one or more results of analysis, one or more decisions, one or more attributes, one or more hashes, or other data relevant to the operation and execution of a supply chain process from a first computer (301) by means of communication (318), a second computer (302) by means of communication (317), or a third computer (303) by means of communication (316). Not shown in System 300, a seventh computer (315) to access external data may receive raw event data (101), processed event data (102), meta event data (103), one or more results of analysis, one or more decisions, one or more attributes, one or more hashes, or other data relevant to the operation and execution of a supply chain process from a fourth computer (304), a fifth computer (305), or another instance of a sixth computer to access external data by means of communication.

A sixth computer (315) to access external data (319) may send raw event data (101), processed event data (102), meta event data (103), one or more results of analysis, one or more decisions, one or more attributes, one or more hashes, or other data relevant to the operation and execution of a supply chain process utilizing an autonomous vehicle to a first computer (301) by means of communication (318), a second computer (302) by means of communication (317), or a third computer (303) by means of communication (316). Not shown in System 300, a sixth computer (315) to access external data (319) may send raw event data (101), processed event data (102), meta event data (103), one or more results of analysis, one or more decisions, one or more attributes, one or more hashes, or other data relevant to the operation and execution of a supply chain process utilizing an autonomous vehicle to a fourth computer (304), a fifth computer (305), or another instance of a sixth computer to access external data by means of communication.

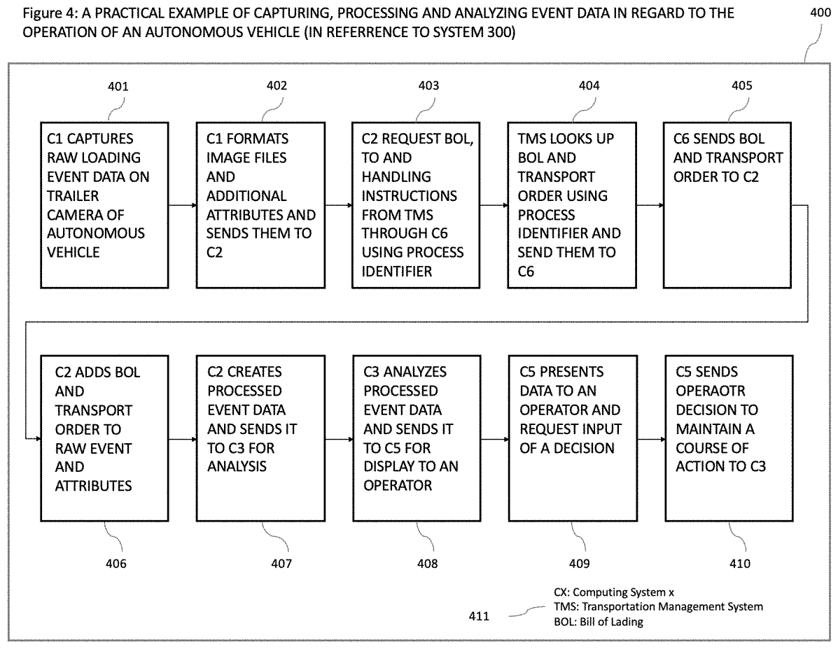

Referring to FIG. 4, shown is Block Diagram 400 comprising a flow to illustrate a practical example for loading of materials onto an autonomous vehicle in a transportation process in reference to system 300. Block diagram 400 comprises of ten steps to capture, process, analyze and share a raw loading event (101) for an autonomous vehicle in a freight transportation process. Raw loading event data (101) in the form of still images may be captured by a camera mounted in the back of a trailer that may be triggered by light, motion or weight sensors, or any combination thereof, to begin recording as soon as loading activity is detected (401) A first computer (301) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (402) A first computer (301) sends the raw event data (101) and additional data in the form of attributes to a second computer (302) for processing (still 402) A second computer (302) may request additional event attributes such as a bill of lading (BOL), transport order (TO), or handling instructions from a sixth computer (315) to access external systems (319), in this particular example interfacing into a transportation management system (TMS) controlled and operated by a shipper of the freight (403). A sixth computer (315) to access external data (319) interfaces into a shipper TMS, which looks up and retrieves the requested files based on a transaction or process identifier (404), processes them for transmission and sends them to a seventh computer (315) to access external data, which in turn sends them to a second computer (302) (405). A second computer (302) adds the additional files to the existing raw loading event data (101) captured on still images and its already established attributes (406). A second computer (302) then assembles the available data into one or more electronic files to create processed event data (102), which it sends to a third computer (303) for analysis (407) In some embodiment of the present invention, a human operator may assess the processed event data (102) before it is further handled. In other embodiments of the present invention, a software program may perform the activities of assessing that the event data has been properly processed. A third computer (303) analyzes the event data further and then sends it to a fifth computer (305) for display to a human operator (408). The fifth computer (305) presents the processed event data to a human operator and requests an input from the human operator whether to continue to follow a course of action or to change to a different course of action. In this example, the human operator may look at the photos of the loading process, the transport documents and any instruction on how to load the freight in order to validate that it has been correctly loaded. To maintain a course of action, the delivery of materials to a destination for example, the human operator may take no action. Once a course of action has been documented, a fifth computer (305) may send the decision to a third computer (303) to add to the analysis (410). An index of abbreviations used in the diagram is shown (411).

Not shown in Block Diagram 400, a sixth computer (315) providing access to and, in some embodiments of the present invention, an interface into external data sources (319) may now also be updated. For example, a third computer (303) may add an estimated time of arrival to a loading complete notification that is sent to a sixth computer (315). Further not shown in Block Diagram 400, a fourth computer (304) may receive processed event data (102) to store it. Still further not shown in Block Diagram 400, a multitude of additional parties including, but not limited to, a freight forwarder, a broker, or an end-user of the materials may also be notified by a third computer (303). Still further not shown in Block Diagram 400, a shipper TMS may be updated with an estimated time of arrival by a sixth computer (315) to access external systems (319) as well. Still further not shown in Block Diagram 400 is a case when a verification of a loading process does not occur because materials may be missing or visibly damaged, or because special handling instructions, for example the use of an air ride trailer or the use of straps to secure freight, were not completely observed. In this scenario, a third computer (303) may alert all relevant parties that one or more corrective actions are necessary before the supply chain asset may leave a loading dock area. The resulting execution of corrective measures, possibly ranging from an exchange of materials to a stricter adherence to special instructions, comprises new raw loading event data (101) and the process described in Block Diagram 400 may now repeat itself until a loading process has been successfully completed. As a potential consequence, a new course of action may now become necessary in case the repeated loading process exceeds a time limit available for a timely delivery of the materials at a recipient location. This, too, may trigger an exception process to prepare the recipient for delays in the arrival of the materials.

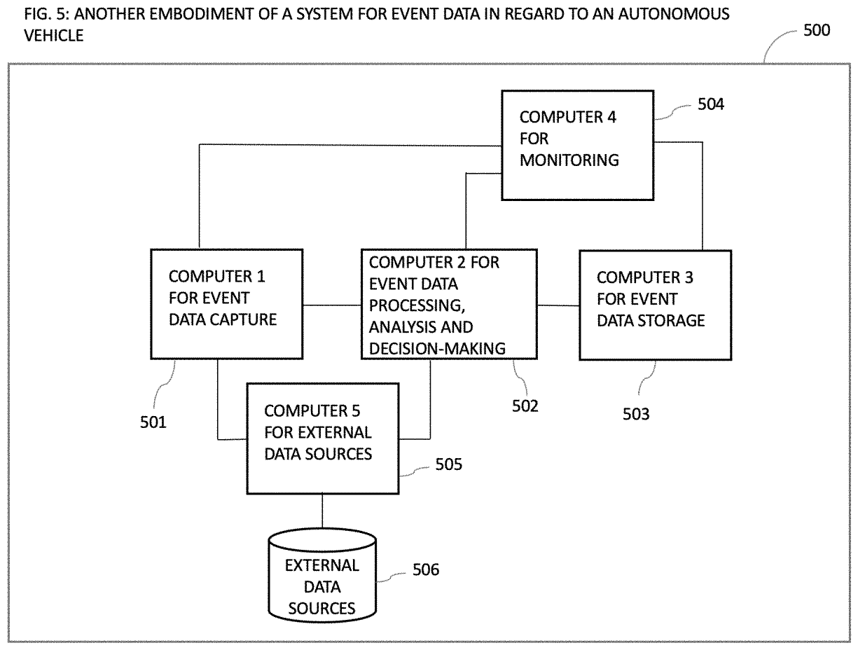

Referring to FIG. 5, another embodiment of the present invention for supply chain event data utilizing an autonomous vehicle is shown. System 500 comprises of five computers used in the capture, formatting, processing, analysis, monitoring, decision-making, sharing and storing of event data utilizing an autonomous vehicle. Event data may be captured on a first computer (501), then being sent to a second computer (502) for processing, analysis and decision-making, then being sent to a third computer (503) for storage, then being sent to a fourth computer (504) for monitoring other computers and displaying data to local or remote human or machine operators or controllers, and in some embodiments of the present invention for decision-making, and a fifth computer (505) to access external data (506). The embodiment of the present invention shown in System 500 functions as described in System 300 with the exception that two separate computers for processing, and analysis and decision-making have been combined into one computer (502).

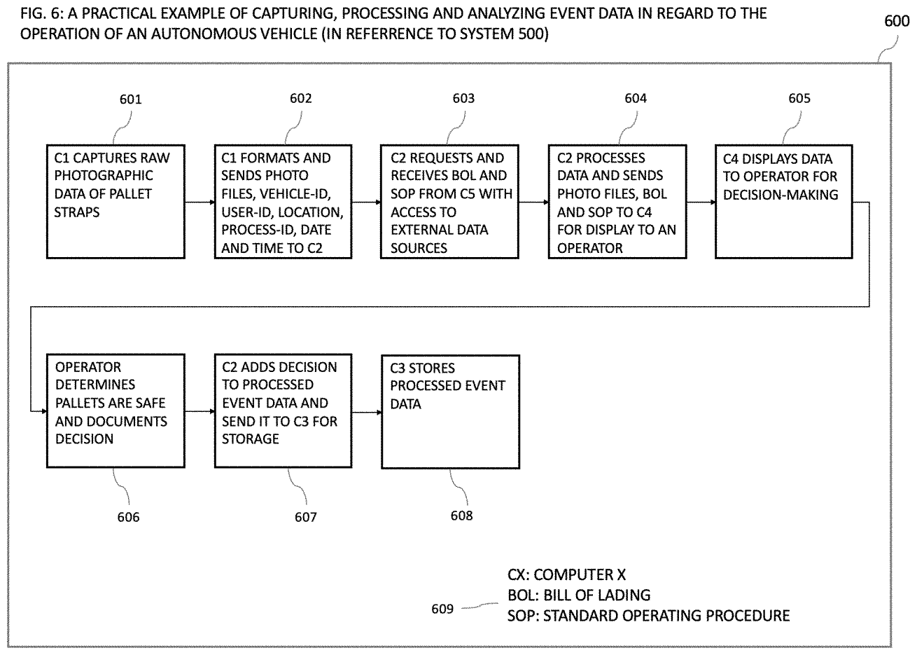

Referring to FIG. 6, shown is Block Diagram 600 comprising a flow to illustrate a practical example in reference to system 500 for the capture of raw event data (101) and additional attributes for the creation of processed event data (102) to enable decision-making by a local or remote human or machine operator or controller. Block diagram 600 comprises of eight steps to capture, process, analyze and share raw event (101) loading photos for an autonomous vehicle in a freight transportation process. Raw loading event data (101) in the form of still images may be captured by a camera mounted in the back of a trailer that may be triggered by light, motion or weight sensors, or any combination thereof, to begin recording as soon as loading activity is detected (601). A first computer (501) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera II)), a transaction or process identifier (process ID), or a date and time stamp (602) and sends them to a second computer (502) (602). The second computer (502) may request additional event attributes such as a bill of lading (BOL) or standard operating procedure (SOP) from a fifth computer (505) to access external systems (506) by using the process identifier as a reference, in this particular example interfacing into a transportation management system (TMS) controlled and operated by the shipper of the freight (603). The second computer (502) receives the additionally requested data and processes the raw event data (101) and all additional attributes into processed event data (102) which it sends it to a fourth computer (504) for display to a human operator (604). A fourth computer (504) displays the processed event data (102), which includes the photo files, bill of lading and standard operating procedure to a human operator (605). The human operator assesses the processed event data (102) and determines that the pallets have been secured safely to the supply chain asset (606). The human operator documents his decision, for example by indicating to a computer software that the pallets are safe (still 606). Not shown in Block Diagram 600 is that the human operator decision can be documented on a fourth computer (504) in some embodiments of the present invention and that a fourth computer (504) then sends the information to a second computer (502). In other embodiments of the present invention a fourth computer (504) may only serve as an information display computer that allows access to a second computer (502) for the human operator. Shown again in Block Diagram 600, the second computer (502) adds the decision to the already existing raw event data (101) and processed event (102) data and sends all data to a third computer (503) for storage (607). A third computer (503) stores all data (608). An index of abbreviations used in the diagram is shown in (609).

Not shown in Block Diagram 600, a software program may perform the activities of assessing that the materials have been properly loaded and secured onto the trailer of a supply chain asset (606). Further not shown, once a human operator or software program validates that all materials were properly loaded, a second computer (502) may also send a notification of the results of the analysis to the owner or operator of the autonomous vehicle, a shipper, a carrier and the recipient of the freight. A fifth computer (505) providing access to and, in some embodiments of the present invention, an interface into external data sources (506) may now also be updated. Still further not shown in Block Diagram 600, a multitude of additional parties including, but not limited to, a freight forwarder, a broker, or an end-user of the materials may also be notified by a second computer (502). Still further not shown are cases where materials are not properly secured to a supply chain asset.

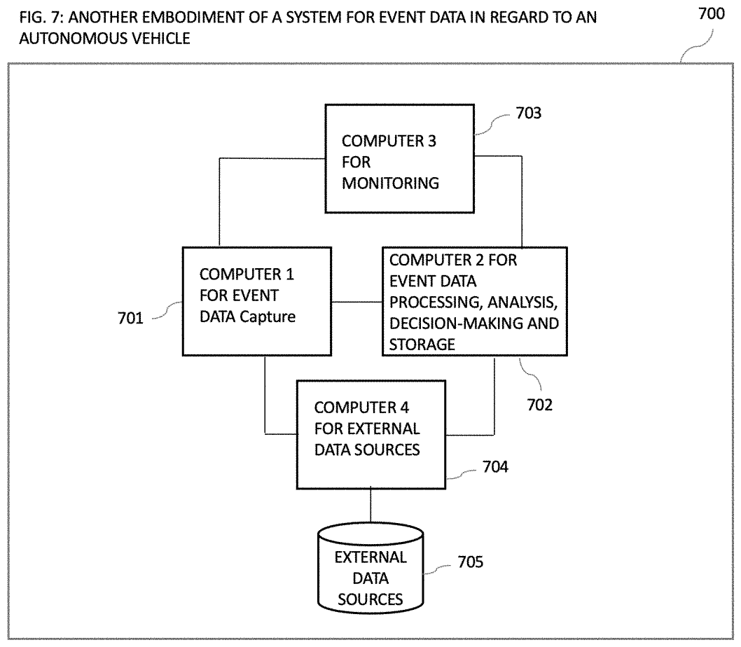

Referring to FIG. 7, another embodiment of the present invention for supply chain event data utilizing an autonomous vehicle is shown. System 700 comprises of four computers used in the capture, formatting, processing, analysis, monitoring, decision-making, sharing and storing of event data utilizing an autonomous vehicle. Event data may be captured on a first computer (701), then being sent to a second computer (702) for processing, analysis, decision-making and storage, then being sent to a third computer (703) for monitoring other computers and displaying data to local or remote human or machine operators or controllers, and in some embodiments of the present invention for decision-making, and a fourth computer (704) to access external data (705). The embodiment of the present invention shown in System 700 functions as described in System 300 with the exception that three separate computers for processing, analysis, decision-making and storage have been combined into one computer (702).

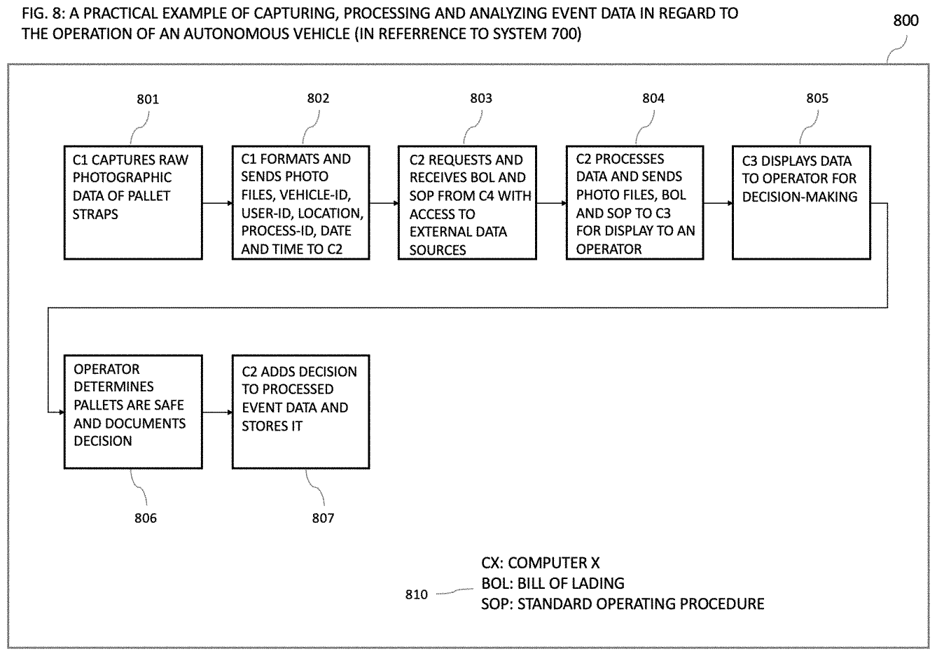

Referring to FIG. 8, shown is Block Diagram 800 comprising a flow to illustrate a practical example in reference to system 700 for the capture of raw event data (101) and additional attributes for the creation of processed event data (102) to enable decision-making by an operator or controller. Block diagram 800 comprises of seven steps to capture, process, analyze and share raw event (101) loading photos for an autonomous vehicle in a freight transportation process. Raw loading event data (101) in the form of still images may be captured by a camera mounted in the back of a trailer that may be triggered by light, motion or weight sensors, or any combination thereof, to begin recording as soon as loading activity is detected (801). A first computer (701) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (802) and sends them to a second computer (702) (802). The second computer (702) may request additional event attributes such as a bill of lading (BOL) or standard operating procedure (SOP) from a fourth computer (704) to access external systems (705) by using the process identifier as a reference, in this particular example interfacing into a transportation management system (TMS) controlled and operated by the shipper of the freight (803). The second computer (702) then processes the raw event data (101) and all additional attributes into processed event data (102) which it sends it to a third computer (703) (804) for display to a human operator. A third computer (703) displays the processed event data (102), which includes the photo files, bill of lading and standard operating procedure to a human operator (805). The human operator assesses the processed event data (102) and determines that the pallets have been secured safely to the supply chain asset (806). The human operator documents his decision, for example by indicating to a computer software that the pallets are safe (still 806). Not shown in Block Diagram 800 is that the human operator decision can be documented on a third computer (703) in some embodiments of the present invention and that a third computer (703) then sends the information to a second computer (702). In other embodiments of the present invention a third computer (703) may only serve as an information display computer that allows access to a second computer (702) for the human operator. Shown again in Block Diagram 800, the second computer (702) adds the decision to the already existing raw event data (101) and processed event data (102) and stores all data (807). An index of abbreviations used in the diagram is shown in (808).

Not shown in Block Diagram 800, a software program may perform the activities of assessing that the materials have been properly loaded and secured onto the trailer of a supply chain asset (806). Further not shown, once a human operator or software program validates that all materials were properly loaded, a second computer (702) may also send a notification of the results of the analysis to the owner or operator of the autonomous vehicle, a shipper, a carrier and the recipient of the freight. A fourth computer (704) providing access to and, in some embodiments of the present invention, an interface into external data sources (705) may now also be updated. Still further not shown in Block Diagram 800, a multitude of additional parties including, but not limited to, a freight forwarder, a broker, or an end-user of the materials may also be notified by a second computer (702). Still further not shown are cases where materials are not properly secured to a supply chain asset.

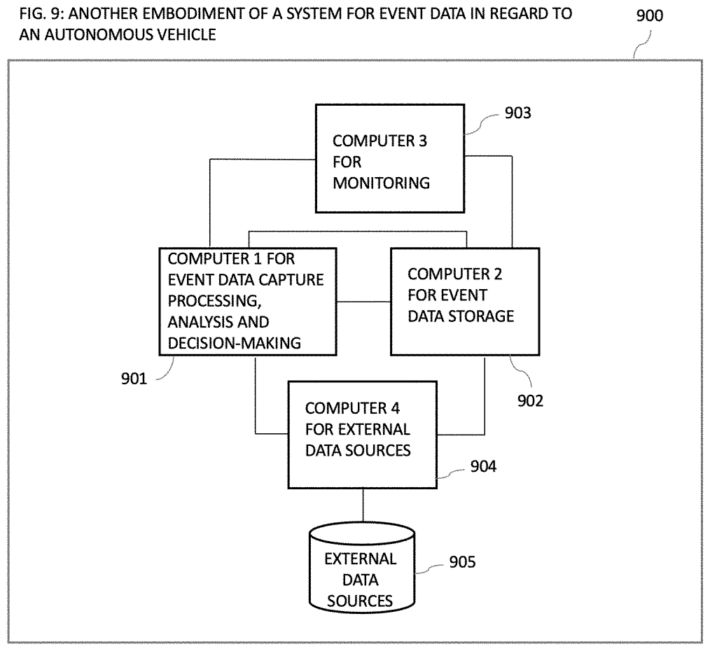

Referring to FIG. 9, another embodiment of the present invention for supply chain event data utilizing an autonomous vehicle is shown System 900 comprises of four computers used in the capture, formatting, processing, analysis, monitoring, decision-making, sharing and storing of event data utilizing an autonomous vehicle. Event data may be captured, processed, analyzed, or one or more decisions being made on a first computer (901), then being sent to a second computer (902) for storage, then being sent to a third computer (903) for monitoring other computers and displaying data to local or remote human or machine operators or controllers, and in some embodiments of the present invention for decision-making, and a fourth computer (904) to access external data (905). The embodiment of the present invention shown in System 900 functions as described in System 300 with the exception that three separate computers for capture, processing, analysis and decision-making have been combined into one computer (901).

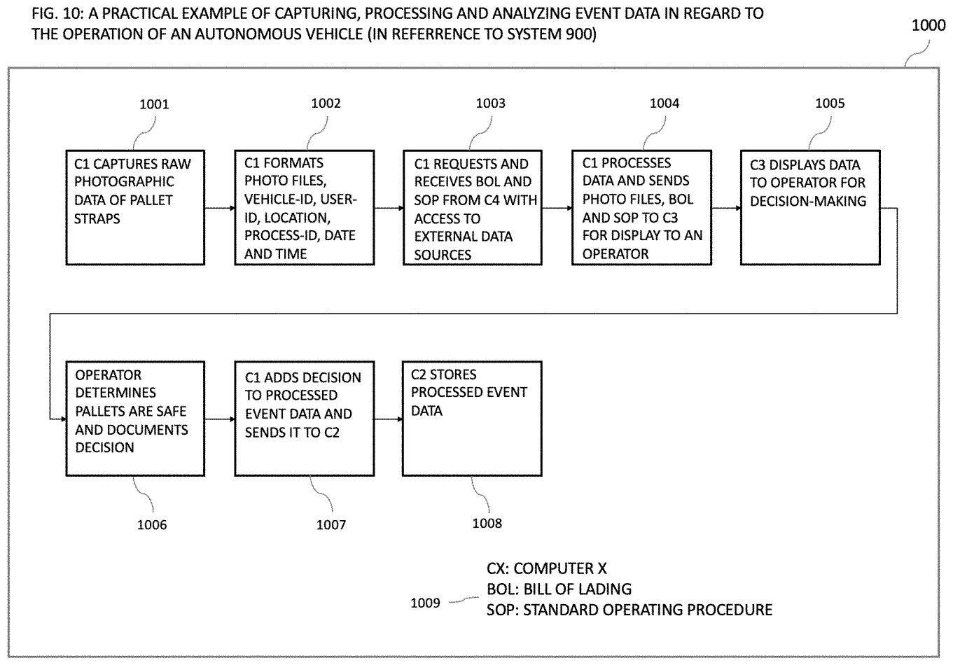

Referring to FIG. 10, a Block Diagram 1000 for capturing of raw event data (101) and additional attributes for the creation of processed event data (102) to enable decision-making by an operator utilizing the system 900 is illustrated. Block Diagram 1000 comprises of eight steps to capture, process, analyze and share raw event (101) loading photos for a supply chain asset in a freight transportation process. Raw loading event data (101) in the form of still images may be captured by a camera mounted in the back of a trailer that may be triggered by light, motion or weight sensors, or any combination thereof, to begin recording as soon as loading activity is detected (1001). A first computer (901) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (1002). The first computer (901) may request additional event attributes such as a bill of lading (BOL) or standard operating procedure (SOP) from a fourth computer (904) to access external systems by using the process identifier as a reference, in this particular example interfacing into a transportation management system (TMS) controlled and operated by the shipper of the freight (1003). The first computer (901) then processes the raw event data (101) and additional attributes into processed event data (102) which it sends it to a third computer (903, 1004). A third computer (903) displays the processed event data (102), which includes the photo files, bill of lading and standard operating procedure to a human operator (1005). The human operator assesses the processed event data (102) and determines that the pallets have been secured safely to the supply chain asset (1006). The human operator documents his decision, for example by indicating to a computer software that the pallets are safe (1006). Not shown in Block Diagram 1000 is that the human operator decision can be documented on a third computer (903) in some embodiments of the present invention. In other embodiments of the present invention a third computer (903) may only serve as an information display computer that allows access to a first computer (901) for the human operator Shown again in Block Diagram 1000, the first computer (901) adds the decision to the already existing raw event data (101) and processed event (102) data and sends all data to a second computer (902) for storage (1007). A second computer (902) stores all data (1008). An index of abbreviations used in the diagram is shown in (1009).

Not shown in Block Diagram 1000, a software program may perform the activities of assessing that the materials have been properly loaded and secured onto the trailer of a supply chain asset (1006). Further not shown, once a human operator or software program validates that all materials were properly loaded, a first computer (901) may also send a notification of the results of the analysis to the owner or operator of the autonomous vehicle, a shipper, a carrier and the recipient of the freight. A fourth computer (904) providing access to and, in some embodiments of the present invention, an interface into external data sources (905) may now also be updated. Still further not shown in Block Diagram 1000, a multitude of additional parties including, but not limited to, a freight forwarder, a broker, or an end-user of the materials may also be notified by a first computer (901). Still further not shown are cases where materials are not properly secured to a supply chain asset.

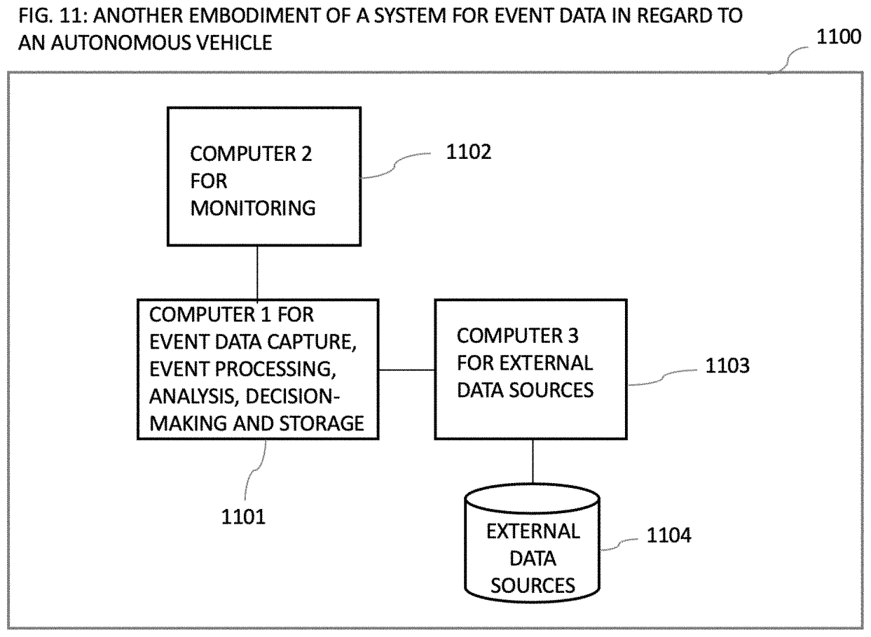

Referring to FIG. 11, another embodiment of the present invention for supply chain event data utilizing an autonomous vehicle is shown. System 1100 comprises of three computers used in the capture, formatting, processing, analysis, monitoring, decision-making, sharing and storing of event data utilizing an autonomous vehicle. Event data may be captured, processed, analyzed, one or more decisions being made, or stored on a first computer (1101), then being sent to a second computer (1102) for monitoring other computers and displaying data to local or remote human or machine operators or controllers, and in some embodiments of the present invention for decision-making, and a third computer (1103) to access external data (1104). The embodiment of the present invention shown in System 1100 functions as described in System 300 with the exception that four separate computers for capture, processing, analysis, decision-making and storage have been combined into one computer (1101).

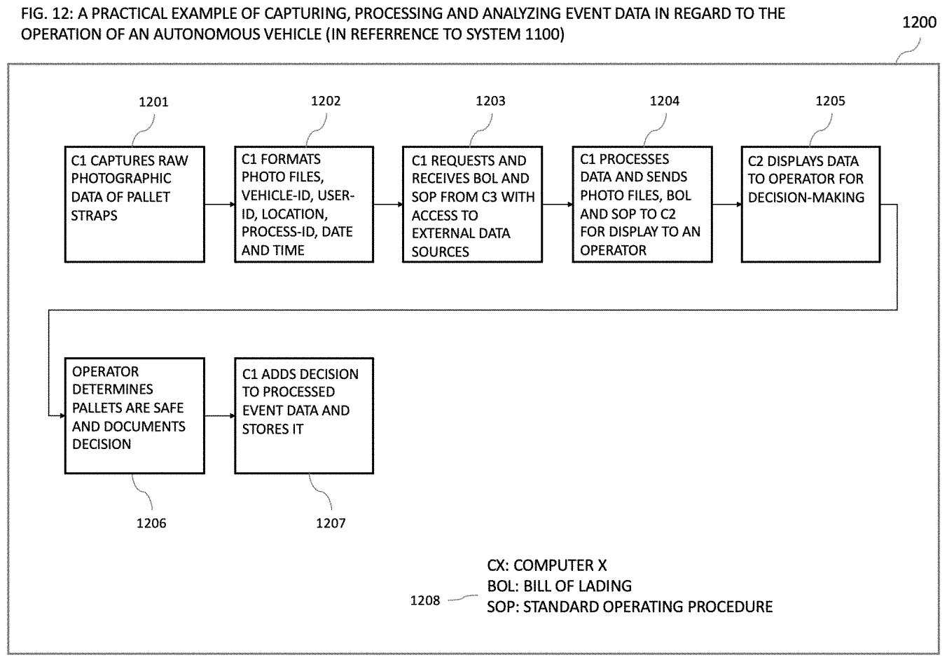

Referring to FIG. 12, shown is Block Diagram 1200 comprising a flow to illustrate a practical example in reference to system 1100 for the capture of raw event data (101) and additional attributes for the creation of processed event data (102) to enable decision-making by an operator. Block diagram 1200 comprises of seven steps to capture, process, analyze and share raw event (101) loading photos for a supply chain asset in a freight transportation process. Raw loading event data (101) in the form of still images may be captured by a camera mounted in the back of a trailer that may be triggered by light, motion or weight sensors, or any combination thereof, to begin recording as soon as loading activity is detected (1201). A first computer (l 101) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (1202). The first computer (1101) may request additional event attributes such as a bill of lading (BOL) or standard operating procedure (SOP) from a third computer (1103) to access external systems (1104) by using the process identifier as a reference, in this particular example interfacing into a transportation management system controlled and operated by the shipper of the freight (1203). The first computer (1101) then processes the raw event data (101) and additional attributes into processed event data (102) which it sends it to a second computer (1102) for display to a human operator (1204) A second computer (1102) displays the processed event data (102), which includes the photo files, bill of lading and standard operating procedure to a human operator (1205). The human operator assesses the processed event data (102) and determines that the pallets have been secured safely to the supply chain asset (1206). The human operator documents his decision, for example by indicating to a computer software that the pallets are safe (still 1206). Not shown in Block Diagram 1200 is that the human operator decision can be documented on a second computer (1102) in some embodiments of the present invention. In other embodiments of the present invention a second computer (1102) may only serve as an information display computer that allows access to a first computer (1101) for the human operator. Shown again in Block Diagram 1200, the first computer (1101) adds the decision to the already existing raw event data (101) and processed event (102) data and stores all data (1207). An index of abbreviations used in the diagram is shown in (1208).

Not shown in Block Diagram 1200, a software program may perform the activities of assessing that the materials have been properly loaded and secured onto the trailer of a supply chain asset (1206). Further not shown, once a human operator or software program validates that all materials were properly loaded, a first computer (1101) may also send a notification of the results of the analysis to the owner or operator of the autonomous vehicle, a shipper, a carrier and the recipient of the freight. A third computer (1103) providing access to and, in some embodiments of the present invention, an interface into external data sources (1104) may now also be updated. Still further not shown in Block Diagram 1200, a multitude of additional parties including, but not limited to, a freight forwarder, a broker, or an end-user of the materials may also be notified by a first computer (1101). Still further not shown are cases where materials are not properly secured to a supply chain asset.

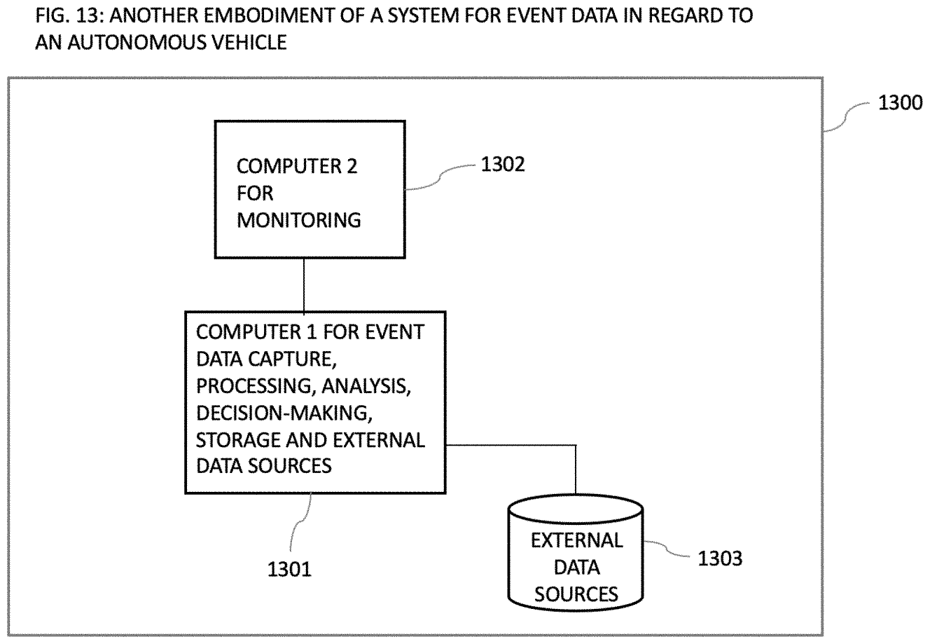

Referring to FIG. 13, another embodiment of the present invention for supply chain event data utilizing an autonomous vehicle is shown System 1300 comprises of two computers used in the capture, formatting, processing, analysis, monitoring, decision-making, sharing and storing of event data utilizing an autonomous vehicle. Event data may be captured, processed, analyzed, external data (1303) being accessed, one or more decisions being made, or stored on a first computer (1301), then being sent to a second computer (1302) for monitoring other computers and displaying data to local or remote human or machine operators or controllers, and in some embodiments of the present invention for decision-making. The embodiment of the present invention shown in System 1300 functions as described in System 300 with the exception that five separate computers for capture, processing, analysis, access to external data, decision-making and storage have been combined into one computer (1301).

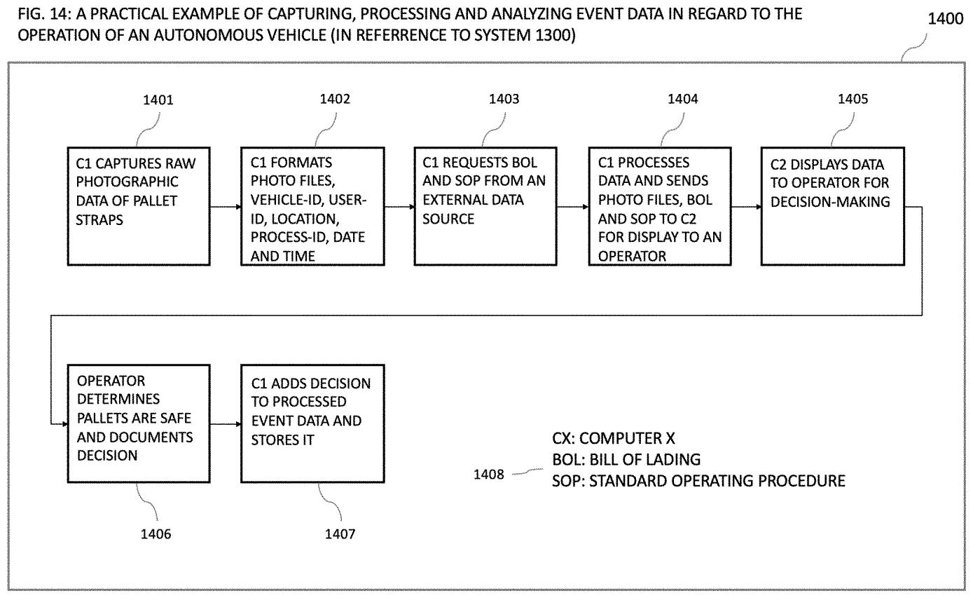

Referring to FIG. 14, shown is Block Diagram 1400 comprising a flow to illustrate a practical example in reference to system 1300 for the capture of raw event data (101) and additional attributes for the creation of processed event data (102) to enable decision-making by an operator. Block diagram 1400 comprises of seven steps to capture, process, analyze and share raw event (101) loading photos for a supply chain asset in a freight transportation process. Raw loading event data (101) in the form of still images may be captured by a camera mounted in the back of a trailer that may be triggered by light, motion or weight sensors, or any combination thereof, to begin recording as soon as loading activity is detected (1401). A first computer (1301) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (1402). The first computer (1301) may request additional event attributes such as a bill of lading (BOL) or standard operating procedure (SOP) from an access external data source in this particular example interfacing into a transportation management system (TMS) controlled and operated by the shipper of the freight (1403). The first computer (1301) then processes the raw event data (101) and additional attributes into processed event data (102) which it sends it to a second computer (1302) (1404). A second computer (1302) displays the processed event data (102), which includes the photo files, bill of lading and standard operating procedure to a human operator (1405). The human operator assesses the processed event data (102) and determines that the pallets have been secured safely to the supply chain asset (1406). The human operator documents his decision, for example by indicating to a computer software that the pallets are safe (1406). Not shown in Block Diagram 1400 is that the human operator decision can be documented on a second computer (1302) in some embodiments of the present invention. In other embodiments of the present invention a second computer (1302) may only serve as an information display computer that allows access to a first computer (1301) for the human operator. Shown again in Block Diagram 1400, the first computer (1301) adds the decision to the already existing raw event data (101) and processed event (102) data and stores all data (1407). An index of abbreviations used in the diagram is shown in (1408).

Not shown in Block Diagram 1400, a software program may perform the activities of assessing that the materials have been properly loaded and secured onto the trailer of a supply chain asset (1406). Further not shown, once a human operator or software program validates that all materials were properly loaded, a first computer (1301) may also send a notification of the results of the analysis to the owner or operator of the supply chain asset, a shipper, a carrier and the recipient of the freight. Still further not shown in Block Diagram 1400, a multitude of additional parties including, but not limited to, a freight forwarder, a broker, or an end-user of the materials may also be notified by a first computer (1301). Still further not shown are cases where materials are not properly secured to a supply chain asset.

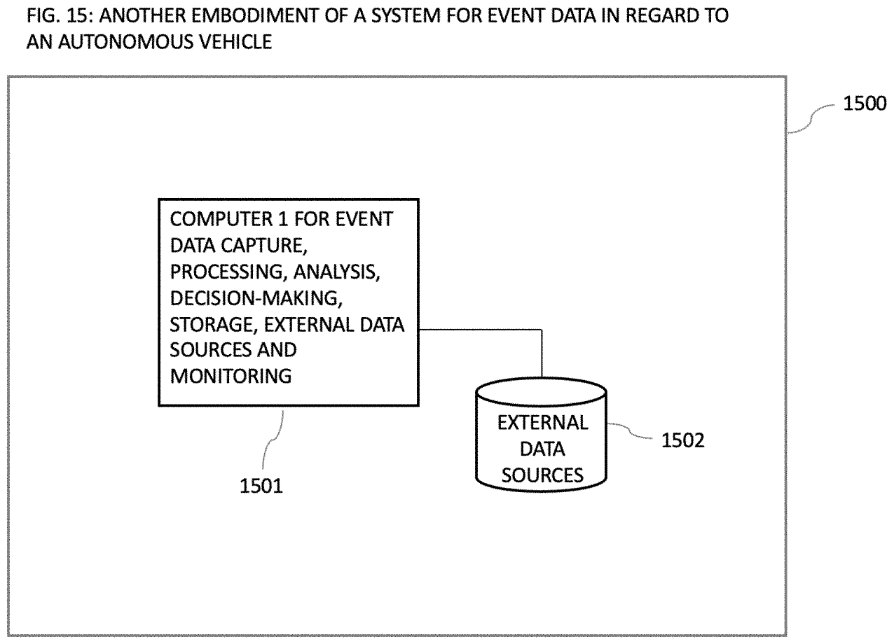

Referring to FIG. 15, another embodiment of the present invention for supply chain event data utilizing an autonomous vehicle is shown. System 1500 comprises of one computer used in the capture, formatting, processing, analysis, monitoring, decision-making, sharing and storing of event data utilizing an autonomous vehicle. Event data may be captured, processed, analyzed, external data (1502) being accessed, one or more decisions being made, monitoring being performed, or data stored on a first computer (1501). The embodiment of the present invention shown in System 1500 functions as described in System 300 with the exception that six separate computers for capture, processing, analysis, access to external data, decision-making, monitoring and storage have been combined into one computer (1501).

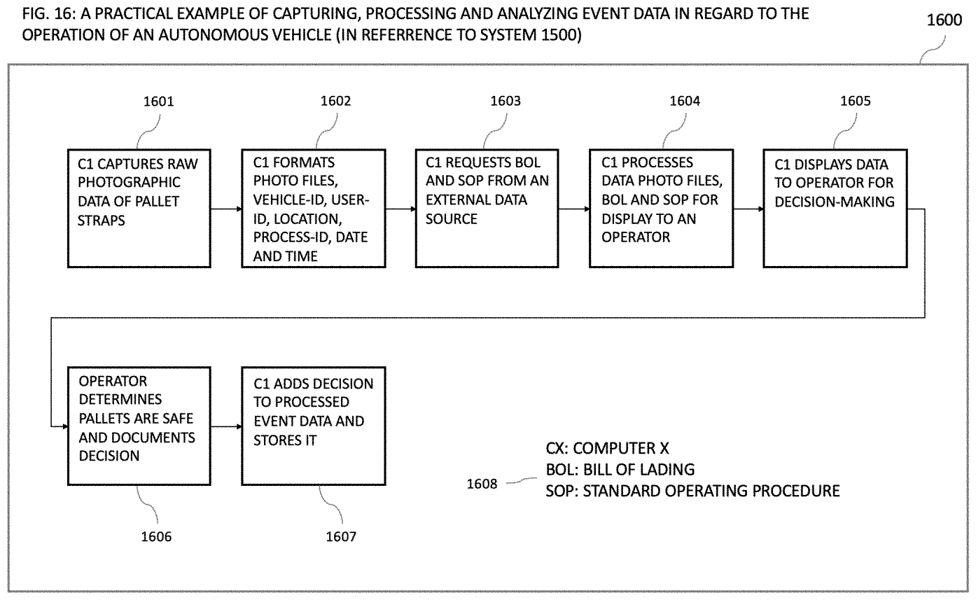

Referring to FIG. 16, shown is Block Diagram 1600 comprising a flow to illustrate a practical example in reference to system 1500 for the capture of raw event data (101) and additional attributes for the creation of processed event data (102) to enable decision-making by an operator. Block diagram 1600 comprises of seven steps to capture, process, analyze and share raw event (101) loading photos for an autonomous vehicle in a freight transportation process. Raw loading event data (101) in the form of still images may be captured by a camera mounted in the back of a trailer that may be triggered by light, motion or weight sensors, or any combination thereof, to begin recording as soon as loading activity is detected (1601) A first computer (1501) to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (1602). The first computer (1501) may request additional event attributes such as a bill of lading (BOL) or standard operating procedure (SOP) from an access external data source (1502) in this particular example interfacing into a transportation management system (TMS) controlled and operated by the shipper of the freight (1603). The first computer (1501) then processes the raw event data (101) and additional attributes into processed event data (102) (1604). A first computer (1501) displays the processed event data (102), which includes the photo files, bill of lading and standard operating procedure to a human operator (1605). The human operator assesses the processed event data (102) and determines that the pallets have been secured safely to the supply chain asset (1606). The human operator documents his decision by indicating to a first computer (1501) that the pallets are safe (still 1606). The first computer (1501) adds the decision to the already existing raw event data (101) and processed event (102) data and stores all data (1607). An index of abbreviations used in the diagram is shown in (1608).

Not shown in Block Diagram 1600, a software program may perform the activities of assessing that the materials have been properly loaded and secured onto the trailer of a supply chain asset (1606). Further not shown, once a human operator or software program validates that all materials were properly loaded, a first computer (1501) may also send a notification of the results of the analysis to the owner or operator of the supply chain asset, a shipper, a carrier and the recipient of the freight Still further not shown in Block Diagram 1600, a multitude of additional parties including, but not limited to, a freight forwarder, a broker, or an end-user of the materials may also be notified by a first computer (1501). Still further not shown are cases where materials are not properly secured to a supply chain asset.

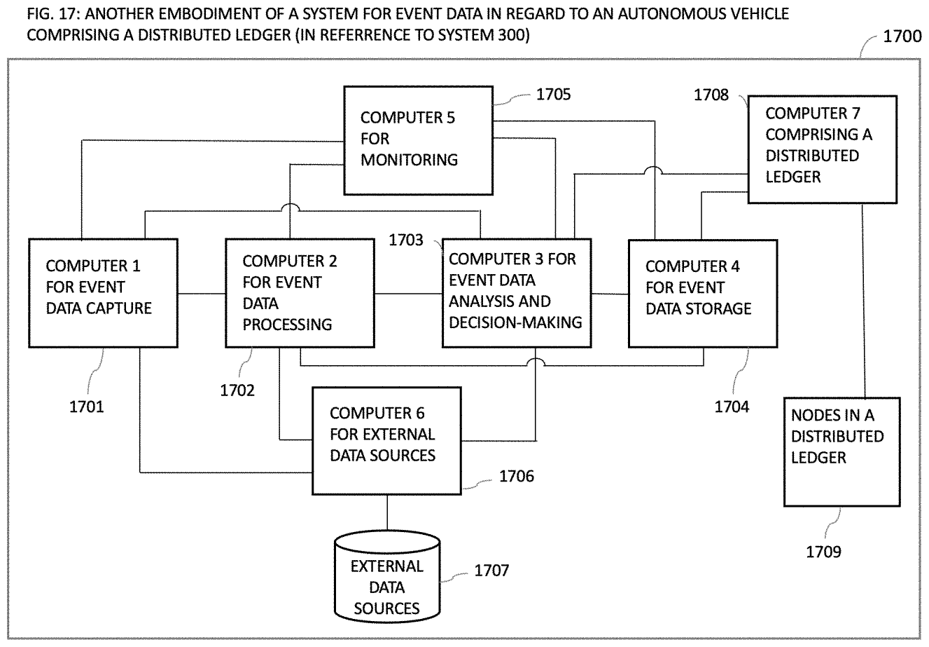

Referring to FIG. 17, another embodiment of the present invention for supply chain event data comprising a distributed ledger and utilizing an autonomous vehicle in reference to System 300 is shown. System 1700 comprises of seven computers used in the capture, formatting, processing, analysis, monitoring, decision-making, hashing, sharing and storing of event data on a distributed ledger. Event data may be captured on a first computer (1701), then being sent to a second computer (1702) for processing, then being sent to a third computer (1703) for analysis and decision-making, then being sent to a fourth computer (1704) for storage, then being sent to a fifth computer (1705) for monitoring other computers, and in some embodiments of the present invention for display to operators or controllers who may input decisions, then being sent to a seventh computer (1708) comprising a distributed ledger and connecting to a network of nodes (1709), and a sixth computer (1706) to access data on external systems (1707). Data residing on an external data source (1707) may include, but is not limited to, raw event data (101), processed event data (102) or meta event data (103), one or more attributes, or other data relevant to the operation and execution of a supply chain process utilizing an autonomous vehicle. System 1700 comprises of seven computers that all receive and send data to one another about the operation and execution of a supply chain process utilizing an autonomous vehicle. The embodiment of the present invention shown in System 1700 functions as described in System 300 with the exception that a seventh computer (1708) comprising a distributed ledger has been added. System 1700 exemplifies principles of how a computer comprising a distributed ledger may be added to all systems described in the present invention disclosure. The same principles are applicable to Systems 500, 700, 900, 1100, 1300 and 1500 described herein.

A distributed ledger including, but not limited to, a Blockchain or Hashgraph, may be public or private. A permissioned distributed ledger is generally a type of a private distributed ledger. A non-permissioned distributed ledger may be a type of public distributed ledger. In some embodiments of the present invention, distributed ledgers may be hybrid forms of private and public distributed ledgers. A distributed ledger may have one or more nodes in a network of nodes. In some embodiments of the present invention, it is conceivable that a private distributed ledger may only have one node. A distributed ledger may reside on one or more computers. A node of a distributed ledger may reside on one or more computers. A computer may host one or more distributed ledgers. A distributed ledger may reside on any of the computers discussed in this invention disclosure.

A seventh computer (1708) comprising a distributed ledger may be used to store event data in a manner shown in Classification 1900. The storage of event data on a distributed ledger may serve as proof to all participants in a supply chain transaction that events, represented by event data, have actually occurred. The storage of event data on a distributed ledger may further serve as an effective way for all parties with access to the distributed ledger to access and view event data while all sharing the same view on the data.

In one embodiment of the present invention, a seventh computer (1708) comprising a distributed ledger may serve as a repository for event data to any other computer shown in System 1700. In another embodiment of the present invention, a seventh computer (1708) comprising a distributed ledger may serve as a repository of event data that did not originate in any of the computers shown in System 1700. In yet another embodiment of the present invention, event data may be stored on a seventh computer (1708) comprising a distributed ledger when it becomes available to any computer shown in System 1700. In a further embodiment of the present invention, event data may be collected, combined and stored on a seventh computer (1708) comprising a distributed ledger in regular intervals such as every hour, every two hours, once per day, etc. In other embodiments of the present invention, a seventh computer (1708) comprising a distributed ledger may serve as a basis for financial decision-making including, but not limited to, a determination of payment amounts, payment due dates, payment terms, bonus payments, insurance payments, toll, fee and charge payments, detention charge payments, determination of pay-to parties, one or more customer charges, or how to split a payment between multiple parties. In certain embodiments of the present invention, event data stored on a seventh computer (1708) comprising a distributed ledger may be displayed on any other computer shown in System 1700 in a way that allows direct access to a distributed ledger.

A seventh computer (1708) comprising a distributed ledger may receive raw event data (101), processed event data (102), meta event data (103), one or more results of analysis, one or more decisions, one or more attributes, one or more hashes, or other data relevant to the operation and execution of a supply chain process from a third computer (1703), or a fourth computer (1704). Not shown in System 1700, a seventh computer (1708) comprising a distributed ledger may receive raw event data (101), processed event data (102), meta event data (103), one or more results of analysis, one or more decisions, one or more attributes, one or more hashes, or other data relevant to the operation and execution of a supply chain process utilizing an autonomous vehicle from a first computer (1701), a second computer (1702), a fifth computer (1705), another instance of a seventh computer (1708) comprising a distributed ledger, or a sixth computer (1706) to access external data (1707) by means of communication.

A seventh computer (1708) comprising a distributed ledger may send raw event data (101), processed event data (102), meta event data (103), one or more results of analysis, one or more decisions, one or more attributes, one or more hashes, or other data relevant to the operation and execution of a supply chain process utilizing an autonomous vehicle to a third computer (1703), or a fourth computer (1704). Not shown in System 1700, a seventh computer (1708) comprising a distributed ledger may send raw event data (101), processed event data (102), meta event data (103), one or more results of analysis, one or more decisions, one or more attributes, one or more hashes, or other data relevant to the operation and execution of a supply chain process to a first computer (1701), a second computer (1702), a fifth computer (1705), a sixth computer (1706) to access external data (1707), or another instance of a seventh computer comprising a distributed ledger by means of communication.

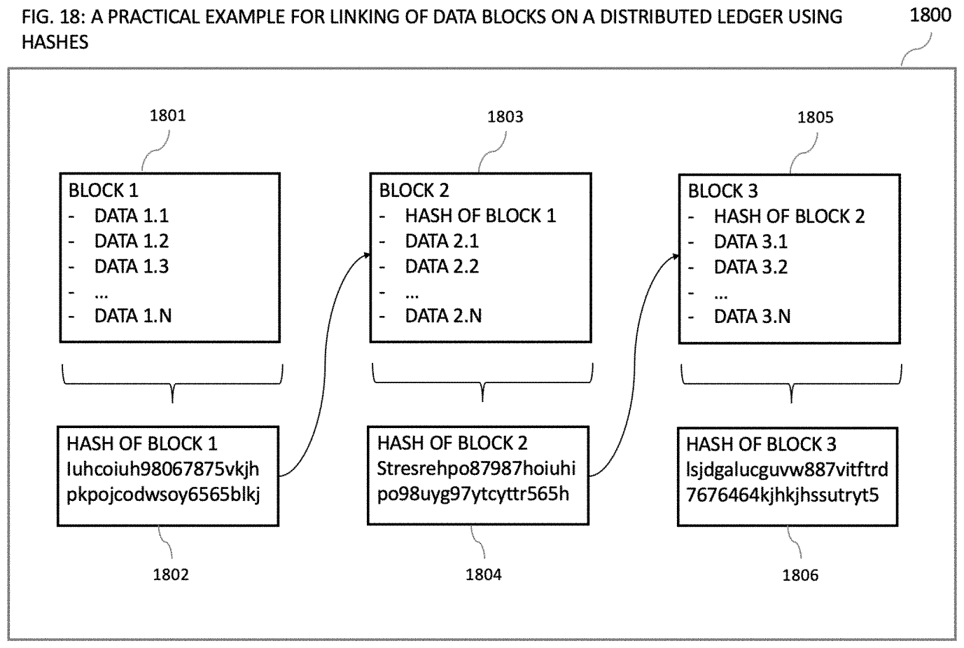

Referring to FIG. 18, a block diagram with a practical example for linking data blocks on a distributed ledger using hashes is shown. Block Diagram 1800 comprises of six elements to illustrate how blocks form a chain on a distributed ledger. The first element (1801) shows a first block in a distributed ledger that is often called a genesis block. Once a block has been established, the nodes in a network write data content (1.1 to 1.n) to the block. The first element (1801) as the first block on a distributed ledger does not contain a hash since no previous blocks exist. When no further data is written to first element (1801), a hash of all data contained in the first block is created (1802). The hash representing the data content of the first block (1801) is written to the second block (1803) and new data content (2.1 to 2.n) is now added to the second block (1803) until that block has been completed. Then a hash of the data content of the second block (1803) is created (1804). The hash representing the second block (1804) is written to a third block and new data content (3.1. to 3.n) is added to the third block (1805) until the third block completes. Then a hash of the data content (1806) of the third block (1805) is created. This process continues for all future blocks on the distributed ledger.

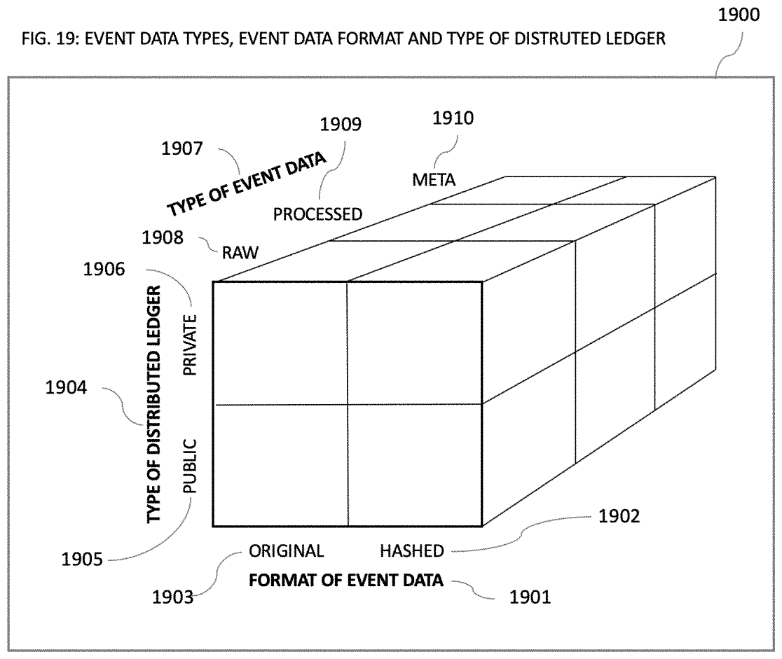

Referring to FIG. 19, different types of event data may be stored in different ways on different types of distributed ledgers. Classification 1900 comprises of three types of event data (1907; 1908-1910) described in Classification 100, two generic formats in which event data (1901, 1902-1903) may be stored on a distributed ledger and two generic types of distributed ledger (1904, 1905-1906). Not shown in Classification 1900, other forms of writing data to blocks including, but not limited to, through encryption or other forms of data abstraction are possible. Raw event data (101, 1908), processed event data (102, 1909), meta event data (103, 1910), one or more attributes, results of an analysis, decisions, or other data relevant to the operation and execution of a supply chain process utilizing a supply chain asset will be referred to as “data” for the purposes of the following description of FIG. 19.

Data itself may be written to a distributed ledger (1904; 1905-1906) in the form of a hash (1902) or in its original format (1903). When data is stored on a distributed ledger in hashed form (1902), a computer applies a hash function to create a hash, or mathematical abstraction, of the original data. This is important to prove at later points in time that the original data has not been changed or altered by a user of a computer system or by the computer system itself. When this proof may be required at a later point in time, a user may create a hash of the original data available in a computer system and compare it to a hash written to a distributed ledger at the time the hash was added. If the first and second hashes do not match, a user knows that the data has been altered or compromised. When data is stored on a distributed ledger in its original form, data formats include, but are not limited to, in complete and unaltered form, in formatted form, in abstracted form, in abbreviated form, in compressed form, or in encrypted form.

A practical example of hashed and whole data is a bill of lading document. In its original form, the document contains data such as information about the shipper and possibly carrier, origin and destination locations, information about materials that are being shipped and other details that describe a shipment transaction. The document itself is the original form in that anyone can read and understand its contents. When a hash algorithm is applied, the contents of the document are represented by a string of characters. A person or computer that analyzes the original data can derive meaning from it while this is not possible when a person or computer analyzes a hash, which is just an abstract string of characters. For example, if the sentence “Today is a warm and pleasant day” is converted into a hash using an MD5 algorithm, the resulting hash is “890863fc4d30a9d4b5fid857fbe3e2ed”. If the sentence is slightly changed, the hash value also changes, which makes it possible to prove that original data inside of a document has changed. For example, if the sentence changes to “Today is a cold and pleasant day” the hash value changes to “eb65089fedc860ca35c3107ddd280b74” using the same algorithm.

As shown in FIG. 19, data may be stored on a private distributed ledger (1906), or a public distributed ledger (1905). Not shown in FIG. 19, data may be stored on a hybrid form of private-public distributed ledger, on two or more private distributed ledgers, on two or more public distributed ledgers, on one or more private and one or more public distributed ledgers, or on two or more distributed ledgers comprising other distributed ledger technologies or platforms. Different distributed ledger technologies or platforms may include, but are not limited to, Bitcoin Blockchain technology, Ethereum Blockchain technology, or Hashgraph technology.

Further not shown in FIG. 19, whole data (1903) may be split into two or more parts before each part is hashed separately and then stored on one, two or more distributed ledgers. Further applying the principle, data in its original form (1903) may be first hashed where the resulting hash (1902) may then be split into two or more parts to be stored on one, two or more distributed ledgers. Two or more hashes of split data in its original form (1903) or two or more parts of a spilt hash (1902) may be stored on two or more private distributed ledgers, on two or more public distributed ledgers, on two or more hybrid distributed ledgers, one or more private and one or more public distributed ledgers, one or more private and one or more hybrid distributed ledgers, one or more hybrid and one or more public distributed ledgers, or one two or more distributed ledgers based on different distributed ledger technologies or platforms.

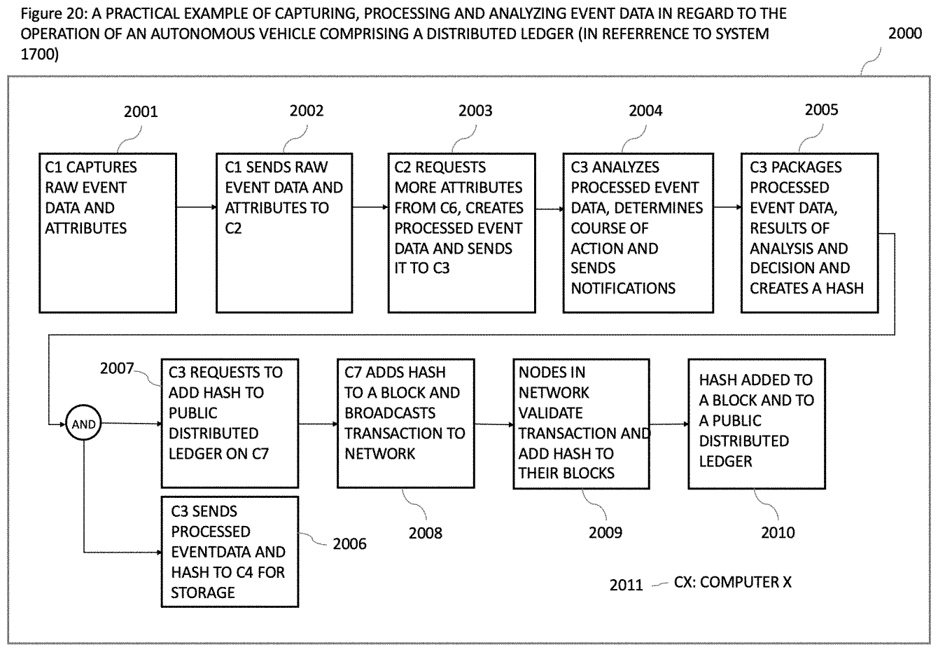

Referring to FIG. 20, shown is a Block Diagram 2000 comprising a flow for storing a hash of a captured event data utilizing an autonomous vehicle on a public distributed ledger in reference to System 1700. The flow shown in Block Diagram 2000 begins with a first computer (1701) capturing raw event data (101) and one or more attributes (2001), then sending the raw event data (101) and one or more attributes to a second computer (1702) (2002). A second computer (1702) requests further attributes comprising additional raw events, additional processed events, one or more meta events, one or more results from an analysis, one or more decisions, or other data relevant to the operation and execution of a supply chain process utilizing an autonomous vehicle at the time the original raw event data (101) was captured from a sixth computer (1706) to access external systems (1707). Upon receipt of the requested data, a second computer (1702) creates processed event data (102), which it sends to a third computer (1703) for analysis and decision-making (2003) A third computer (1703) analyzes the processed event data (102), decides on a course of action and notifies all parties (2004) A third computer (1703) then packages the processed event (102), results of an analysis and decision into one or more files and applies a hashing function to create a hash representing the processed event (102) (2005). A third computer (1703) then sends the processed event data (102) file or files to a fourth computer for storage (1704) (2006). A third computer (1703) then sends the hash of the processed event data (102) to a seventh computer (1708) comprising a distributed ledger with a request to add the hash to a public distributed ledger (2007). A seventh computer (1708) comprising a distributed ledger adds the hash of the processed event data (102) to a block and broadcasts the transaction to a network of nodes (2008). The nodes in a network validate the transaction and add the hash of the processed event data (102) to their respective blocks (2009). As a result, a hash of supply chain event data has been added to a block and to a public distributed ledger (2010). Not shown in block diagram 2000 is a case when whole event data is added to a public or private distributed ledger or when hashed event data is added to a private distributed ledger. An index of abbreviations used in the diagram is shown in (2011).

A practical example of the above block diagram may be when an autonomous vehicle encounters an obstacle during a transport transaction. A first computer (1701) for data capture may be used on the autonomous vehicle and may detect that the velocity of the autonomous vehicle has decreased from average travel speeds to a stop and go behavior while the autonomous vehicle is on a highway. Causes for a slowdown may be heavy traffic, accidents or road construction. The first computer (1701) may send the raw event data (101) of a new travel speed along with the supply chain asset ID and a physical location to a second computer (1702), which sends it to a third computer (1703) which may determine that it requires additional detailed traffic data from an external data source (1707) specifically designed to provide traffic congestion, accident or construction information, which it requests from a sixth computer (1706). When the additional attributes in the form of traffic data are received by the third computer (1703) and from the sixth computer (1706), the third computer (1703) may determine that an accident has occurred and that travel times are extended by two or more hours on the particular stretch of highway where the autonomous vehicle is currently located. The raw event data (101) obtained from the first computer (1701) has already been processed into processed event data (102) through the addition of attributes about the autonomous vehicle and its location it is now further processed through the addition of attributes from the external data source (1707). A third computer (1703) may further assess the raw event data (101) and processed event data (102) to determine that a planned estimated time of arrival (ETA) may no longer be attainable and may calculate a new ETA. The raw event data (101), attributes and results of analysis may then be packaged into a data file by the third computer (1703). The third computer (1703) then creates a hash representing the data file and sends the data file and the hash to a fourth computer (1704) comprising a database for storage. The third computer (1703) also sends the hash to a seventh computer (1708) comprising a public distributed ledger and requests that the hash be added to a block. The seventh computer (1708) comprising a public distributed ledger adds the hash to a block and broadcasts the transaction to a network of nodes (1709), which in turn validates the transaction and adds the hash to its blocks. The hash is now added to a public distributed ledger and the third computer (1703) may then send a notification to all parties involved in the transaction to update the ETA. The recipient of the materials, for example, may use the data to reschedule the use of the incoming freight in this way, a change in a course of action has been shared with all parties involved in the operation and execution of a supply chain process. Further, any party may now also affect a change in a course of action. For example, a recipient of the freight may now as request that the supply chain asset slow down to arrive at a later time than the new ETA to accommodate changes in its business process. Throughout the operation and execution of the supply chain process, decisions are documented on a distributed ledger so that there are no disputes later on and so that all parties have access to the same data.

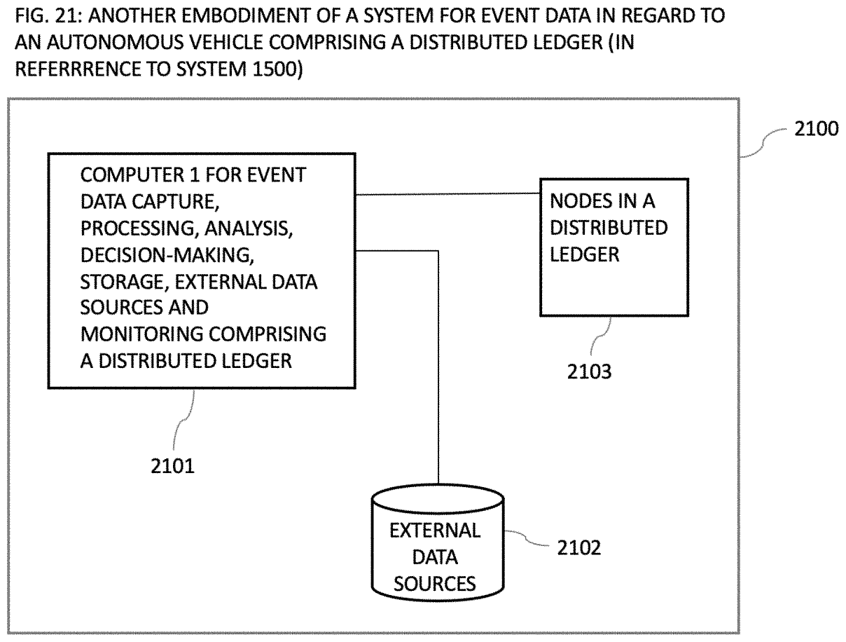

Referring to FIG. 21, another embodiment of the present invention comprising a distributed ledger for supply chain event data utilizing an autonomous vehicle is shown in reference to System 1500. System 2100 comprises of one computer used in the capture, formatting, processing, analysis, monitoring, decision-making, hashing, sharing and storing of event data on a distributed ledger. Event data may be captured, processed, analyzed, external data (2102) being accessed, one or more decisions being made, monitoring being performed, or data stored on a first computer (2101) comprising a distributed ledger for storage and connecting to a network of nodes on a distributed ledger (2103). The embodiment of the present invention shown in System 2100 functions as described in System 1700 with the exception that seven separate computers for capture, processing, analysis, access to external data, decision-making, monitoring, storage and storage on a distributed ledger have been combined into one computer (1601).

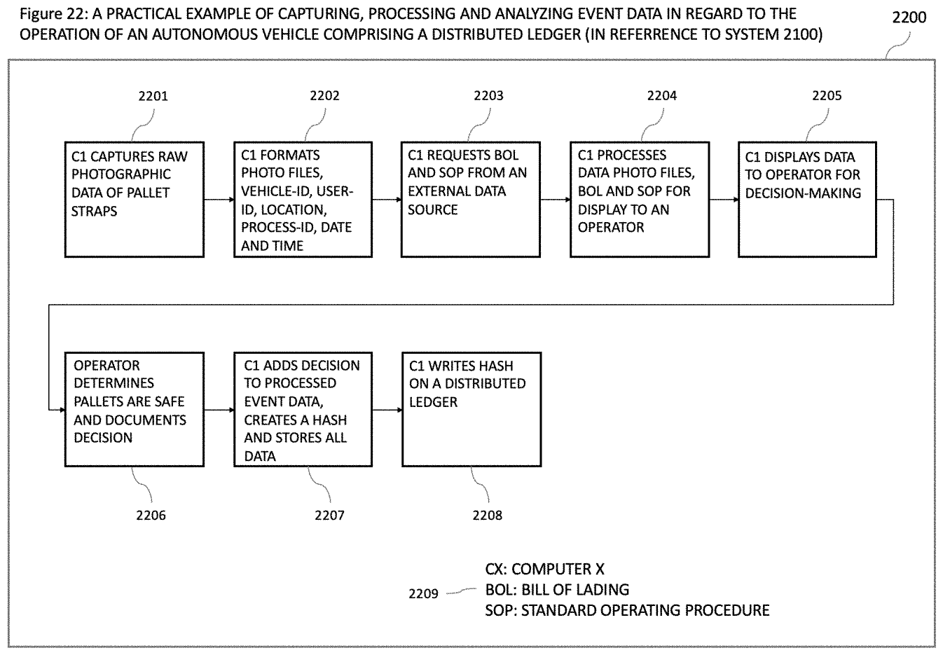

Referring to FIG. 22, shown is Block Diagram 2200 comprising a flow to illustrate a practical example in reference to system 2100 for the capture of raw event data (101) and additional attributes for the creation of processed event data (102) to enable decision-making by an operator. Block diagram 2200 comprises of eight steps to capture, process, analyze and share raw event (101) loading photos for an autonomous vehicle in a freight transportation process. Raw loading event data (101) in the form of still images may be captured by a camera mounted in the back of a trailer that may be triggered by light, motion or weight sensors, or any combination thereof, to begin recording as soon as loading activity is detected (2201). A first computer (2101) comprising a distributed ledger to which the trailer camera may connect or which is embedded in the trailer camera may process the original image files for transmission, for example by compressing the files, and may add attributes such as a vehicle identifier (Vehicle-ID), a vehicle location (Location), a camera identifier (camera ID), a transaction or process identifier (process ID), or a date and time stamp (2202). The first computer (2101) comprising a distributed ledger may request additional event attributes such as a bill of lading (BOL) or standard operating procedure (SOP) from an access external data source (2102) in this particular example interfacing into a transportation management system (TMS) controlled and operated by the shipper of the freight (2203). The first computer (2101) comprising a distributed ledger then processes the raw event data (101) and additional attributes into processed event data (102) (2204). A first computer (2101) comprising a distributed ledger displays the processed event data (102), which includes the photo files, bill of lading and standard operating procedure to a human operator (2205). The human operator assesses the processed event data (102) and determines that the pallets have been secured safely to the supply chain asset (2206). The human operator documents his decision, for example by indicating to a first computer (2101) comprising a distributed ledger that the pallets are safe (2206). The first computer (2101) comprising a distributed ledger adds the decision to the already existing raw event data (101) and processed event (102) data and then creates a hash (202) of all available data and stores all data and the hash (202) (2207). A first computer (2101) comprising a distributed ledger writes the hash (202) on a distributed ledger (2209). An index of abbreviations used in the diagram is shown in (2209).

Not shown in Block Diagram 2200, a software program may perform the activities of assessing that the materials have been properly loaded and secured onto the trailer of an autonomous vehicle (2206). Further not shown, once a human operator or software program validates that all materials were properly loaded, a first computer (2101) comprising a distributed ledger may also send a notification of the results of the analysis to the owner or operator of the supply chain asset, a shipper, a carrier and the recipient of the freight. Still further not shown in Block Diagram 2200, a multitude of additional parties including, but not limited to, a freight forwarder, a broker, or an end-user of the materials may also be notified by a first computer (2101) comprising a distributed ledger. Still further not shown are cases where materials are not properly secured to a supply chain asset. Still further not shown in Block Diagram 2200, a first computer (2101) comprising a distributed ledger may receive raw event data (101), processed event data (102), a result of an analysis, a decision, or other data relevant to the operation of a supply chain asset in the form of whole data (203) to store on a distributed ledger.

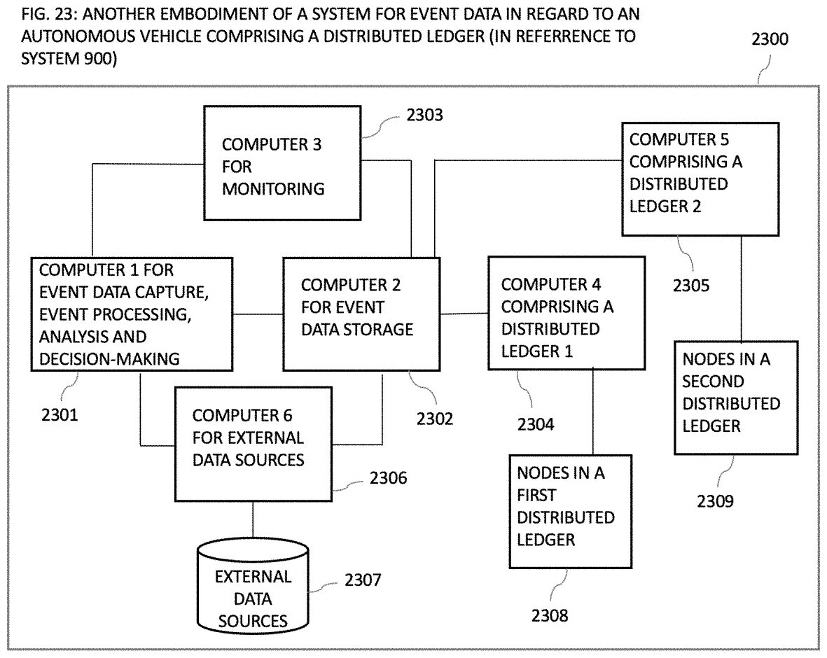

Referring to FIG. 23, another embodiment of the present invention comprising a distributed ledger for supply chain event data utilizing an autonomous vehicle is shown in reference to System 900. System 2300 comprises of six computers used in the capture, formatting, processing, analysis, monitoring, decision-making, hashing, sharing and storing of event data on a distributed ledger. Event data may be captured, processed, analyzed, or one or more decisions being made on a first computer (2301), then being sent to a second computer (2302) for storage, then being sent a third computer (2303) for monitoring other computers and displaying data to local or remote human or machine operators or controllers, and in some embodiments of the present invention for decision-making, then being sent to a fourth computer (2404) comprising a first distributed ledger for storage and connecting to a network of nodes on a distributed ledger (2308), then being sent to a fifth computer (2305) comprising a second distributed ledger and connecting to a network of nodes on a distributed ledger (2309), and a sixth computer (2306) to access external data (2307). System 2300 functions in the same way that System 900 does with the exception that a fourth computer (2304) comprising a first distributed ledger connected to a first network of nodes (2308) and a fifth computer (2305) comprising a second distributed ledger connected to a second network of nodes (2309) has been added. The storage of raw event data (101), processed event data (102), meta event data (103), one or more results of analysis, one or more decisions, one or more attributes, one or more hashes, or other data relevant to the operation and execution of a supply chain process on two or more distributed ledgers may occur in any of the ways listed in Classification 1900 or otherwise described in the present invention disclosure.

A practical example of the embodiment of the present invention shown in Block Diagram 2300 may be the continuous addition of a GPS location coordinates to a blockchain while a supply chain asset is on a route from an origin location to a destination location. Especially when high-value items are transported or when an insurance company may require an immutable record of progress along a route, this may be the case. Once a supply chain asset such as a delivery truck is ready to leave an origin location where it has loaded freight, an operator of the supply chain asset may engage a first computer (2301) such as a smart phone or tablet computer to capture, process, format, store and share a first set of GPS coordinates. A first computer (2301) then captures a pair of latitude and longitude coordinates along with a date and time stamp. A first computer (2301) may now also add additional attributes including, but not limited to, a transaction identifier, a shipping order, a bill of lading, a shipper, a carrier, a recipient, a loading manager signature, a supply chain asset identifier and a supply chain asset operator identifier. A first computer (2301) then processes the raw event data (101) and attributes into processed event data (102) and formats the processed event data (102) by combining it onto a first computer file. A first computer (2301) then sends the first computer file to a second computer (2302) for storage. A first computer (2301) then requests that the first computer file be added to first distributed ledger by a fourth computer (2304) comprising a first distributed ledger. A fourth computer (2304) comprising a first distributed ledger adds the first computer file to a block and broadcasts the transaction to a first network of nodes (2308), which in turn validate the transaction and add the computer file to their blocks. As a result, the first computer file has been added to a block and a first distributed ledger. A first computer (2301) then requests that the first computer file be added to second distributed ledger by a fifth computer (2305) comprising a second distributed ledger. A fifth computer (2305) comprising a second distributed ledger adds the first computer file to a block and broadcasts the transaction to a second network of nodes (2309), which in turn validate the transaction and add the computer file to their blocks. As a result, the first computer file has been added to a block and a second distributed ledger. This process may now repeat itself by creating a second, third and so forth computer file each time new GPS location coordinates have been captured, which provides a consistent view of how the supply chain asset progresses from an origin location to a destination location, until the autonomous vehicle reaches its location.

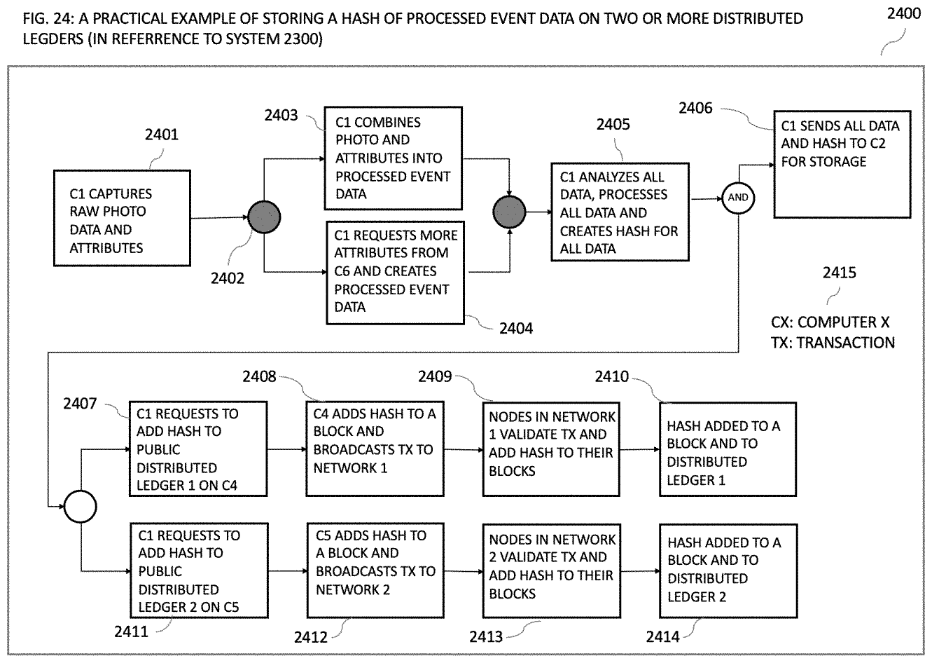

Referring to FIG. 24, shown is Block Diagram 2400 comprising a flow for storing a hash of event data on two or more public distributed ledgers in reference to System 2300. Block diagram 2400 comprises of fourteen steps to store a hash of event data on two or more public distributed ledgers. The flow shown in Block Diagram 2400 begins with a first computer (2301) capturing raw event data (101) and one or more attributes (2401) A first computer (2301) then determines whether further processing of the raw event data is necessary (2402), which may not be the case when only the raw event data (101) may be added to two or more distributed ledgers. In cases where raw event data (101) may be transformed into processed event data (102), either the attributes captured by a first computer (2301) suffice to create processed event data (102) (2403) or a first computer (2301) may request further attributes comprising additional raw event data, additional processed event data, additional meta event data, one or more results from analysis, one or more decisions, one or more hashes, or other data relevant to the operation and execution of a supply chain process utilizing an autonomous vehicle at the time the initial raw event data (101) was captured from a sixth computer (2306) to access external data (2307) (2404). A first computer (2301) then analyzes the raw event data (101) or processed event data (102), decides on a course of action, formats the raw event data (101) or processed event data (102) and applies a hashing function to create a hash representing the raw event data (101) or processed event data (102) (2405). Not shown in Block Diagram 2400 is the possibility that a first computer (2301) may also notify affected parties of a decision on a course of action. Shown again in Block Diagram 2400, a first computer (2301) then sends the formatted raw event data (101) or formatted processed event data (102) and the hash to a second computer (2302) for storage (2406). A first computer (2301) then sends the hash to a fourth computer (2304) comprising a first public distributed ledger with a request to add the hash to a first public distributed ledger (2407) A fourth computer (2304) comprising a first public distributed ledger adds the hash to a block and broadcasts the transaction to a first network of nodes (2308) (2408). The nodes in a first network (2308) validate the transaction and add the hash to their respective blocks (2409). As a result, a hash of supply chain event data has been added to a block and to a first public distributed ledger (2410). A first computer (2301) then sends the hash to a fifth computer (2305) comprising a second public distributed ledger with a request to add the hash to a second public distributed ledger (2411). A fifth computer (2305) comprising a second public distributed ledger adds the hash to a block and broadcasts the transaction to a second network of nodes (2309) (2412). The nodes in a second network (2309) validate the transaction and add the hash to their respective blocks (2413). As a result, a hash of supply chain event data has been added to a block and to a second public distributed ledger (2414). An index of abbreviations used in the diagram is shown in (2415).

A practical example of when event data that may be stored on one or more distributed ledger is that different parties involved in the operation and execution of a supply chain transaction may wish to use distributed ledgers in addition to the distributed ledger used by users of the present invention. Another example may be that different parties may prefer the use of different distributed ledger technologies, which would necessitate the writing of event data to more than one distributed ledger. Still another example may be that an implementation of the present invention may be based on the use of a private distributed ledger where event data that is being written in original form to a private distributed ledger and may also need to be made available to parties such as insurance or financing companies who may only have access to a public distributed ledger where a hash of the same data is stored.

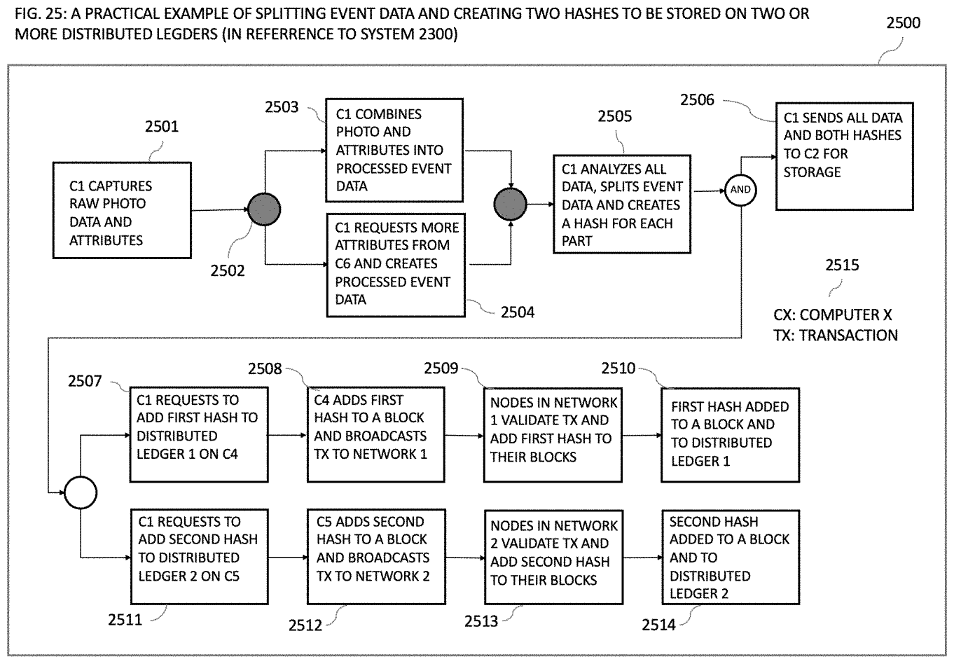

Referring to FIG. 25, shown is Block Diagram 2500 comprising a flow for storing a first hash of a first part of event data on a first public distributed ledger and storing a second hash of a second part of event data on a second public distributed ledger in reference to System 2300. Block diagram 2500 comprises of fourteen steps to store a hash of event data on two or more public distributed ledgers. The flow shown in Block Diagram 2500 begins with a first computer (2301) capturing raw event data (101) and one or more attributes (2501). A first computer (2301) then determines whether further processing of the raw event data is necessary (2502), which may not be the case when only the raw event data (101) may be added to two or more distributed ledgers. In cases where raw event data (101) may be transformed into processed event data (102), either the attributes captured by a first computer (2301) suffice to create processed event data (102) (2503) or a first computer (2301) may request further attributes comprising additional raw event data, additional processed event data, additional meta event data, one or more results from analysis, one or more decisions, one or more hashes, or other data relevant to the operation and execution of a supply chain process utilizing an autonomous vehicle at the time the initial raw event data (101) was captured from a sixth computer (2306) to access external data (2307) (2504). A first computer (2301) then analyzes the raw event data (101) or processed event data (102), decides on a course of action, formats the raw event data (101) or processed event data (102) and then splits the raw event data (101) or processed event data (102) into two parts before applying a hashing function to each part to create two hashes representing the two separate parts of raw event data (101) or processed event data (102) (2505). Not shown in Block Diagram 2500 is a case where event data is first hashed, and the resulting hash is split into two parts afterwards. Further not shown in Block Diagram 2500 are cases where event data is spilt into more than two parts and creating more than two hashes or where a hash representing all event data is split into more than two parts. Further not shown in Block Diagram 2500 is the possibility that a first computer (2301) may also notify affected parties of a decision on a course of action. Shown again in Block Diagram 2500, a first computer (2301) then sends the two parts of raw event data (101) or processed event data (102) along with their two respective hashes to a second computer (2302) for storage (2506). A first computer (2301) then sends a first hash to a fourth computer (2404) comprising a first public distributed ledger with a request to add the first hash to a first public distributed ledger (2507). A fourth computer (2304) comprising a first public distributed ledger adds the first hash to a block and broadcasts the transaction to a first network of nodes (2508). The nodes in a first network (2308) validate the transaction and add the first hash to their respective blocks (2509). As a result, a first hash of supply chain event data has been added to a block and to a first public distributed ledger (2510). A first computer (2301) then sends the second hash to a fifth computer (2305) comprising a second public distributed ledger with a request to add the second hash to a second public distributed ledger (2511). A fifth computer (2305) comprising a second public distributed ledger adds the second hash to a block and broadcasts the transaction to a second network of nodes (2309) (2512). The nodes in a second network (2309) validate the transaction and add the second hash to their respective blocks (2513). As a result, a second hash of supply chain event data has been added to a block and to a second public distributed ledger (2514). An index of abbreviations used in the diagram is shown in (2515).

A practical example of splitting event data or hashes into two or more parts before storing each part on the same or two or more distributed ledgers may be based on information security considerations. The splitting of event data, which is then hashed separately or the hashing of event data, where a hash is then split into two or more parts, allows users to keep the data safe from parties who may not have permission to access any computer discussed in the present invention disclosure. Another practical consideration for the application of split event data or split hashes may be that a first hash or first part of a hash may be stored on a public distributed ledger while a second hash or second part of a hash me be stored on a private distributed ledger.

The use of the term “or” in the claims is used to mean “and/or” unless explicitly indicated to refer to alternatives only or the alternatives are mutually exclusive, although the disclosure supports a definition that refers to only alternatives and to “and/or.” When used in conjunction with the word “comprising” or other open language in the claims, the words “a” and “an” denote “one or more,” unless specifically noted. The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to, possessing only those one or more steps and also covers other unlisted steps.

Unless indicated otherwise, or otherwise clearly contradicted by context, the steps in the methods disclosed herein can be performed in any order.

1. A system for supply chain event management utilizing an autonomous vehicle, comprising:
a computing system capturing first event data during the execution of a supply chain process, and obtaining first and second attributes of the supply chain process;
the computing system making a first determination to either maintain a first course of action in the supply chain process or to change the first course of action in the supply chain process utilizing the first event data and the first and second attributes; and
the computing system generating a first record having the first event data, the first and second attributes, and the first determination, and storing the first record therein.

2. The system of claim 1, wherein:
the computing system further displaying the first record, and receiving input data that indicates a second determination relating to the first course of action of the supply chain process;
the computing system operably communicating with an external data source, the computing system obtaining a third attribute of the supply chain process from the external data source; and
the computing system generating a second record having the first event data, the first, second and third attributes, and the first and second determinations, and storing the second record therein.

3. The system of claim 1, wherein the execution of the supply chain process is performed by a supply chain asset that is self-operating or human-operable.

4. (canceled)

5. The system of claim 1, wherein:
the computing system capturing second event data during the execution of the supply chain process, and obtaining third and fourth attributes of the supply chain process;
the computing system making a second determination to either maintain a second course of action in the supply chain process or to change the second course of action in the supply chain process utilizing the second event data and the third and fourth attributes; and
the computing system generating a second record having the second event data, the third and fourth attributes, and the second determination, and storing the second record therein.

6. (canceled)

7. The system of claim 1, wherein:
the computing system comprises first, second, third, and fourth computers operably communicating with one another;
the first computer capturing the first event data during the execution of the supply chain process, and obtaining the first attribute of the supply chain process that is stored therein, the first computer sending a first message to the second computer, the first message having the first event data and the first attribute of the supply chain process therein;
the second computer sending a second message to the fourth computer in response to the first message, the second message having the first attribute and requesting the second attribute of the supply chain process from the fourth computer;
the fourth computer obtaining the second attribute stored therein utilizing the first attribute in response to the second message, and sending a third message to the second computer having the second attribute therein in response to the second message;
the second computer sending a fourth message to the third computer; the fourth message having the first event data and the first and second attributes of the supply chain process therein;
the third computer making the first determination to either maintain the first course of action in the supply chain process or to change the first course of action in the supply chain process utilizing the first event data and the first and second attributes;
the third computer generating the first record having the first event data, the first and second attributes, and the first determination, and sending a fifth message having the first record therein to the fourth computer; and
the fourth computer storing the first record therein in response to the fifth message.

8. The system of claim 7, wherein:
the computing system further comprises fifth and sixth computers that operably communicate with the first, second, third, and fourth computers;
the fifth computer displaying the first record, and receiving the input data that indicates the second determination relating to the first course of action of the supply chain process, and sending a seventh message having the second determination to the third computer;
the sixth computer operably communicating with an external data source, the sixth computer obtaining a third attribute of the supply chain process from the external data source;
the sixth computer sending an eighth message having the third attribute therein to the third computer; and
the third computer generating a second record having the first event data, the first, second and third attributes, and the first and second determinations, and storing the second record therein.

9. The system of claim 7, wherein:
the supply chain process is a transport of freight;
the first event data is a digital photograph captured during the supply chain process;
the first attribute is a process identifier of the supply chain process;
the second attribute is a second record providing a description of the supply chain process;
the first course of action is a transporting of freight by the supply chain asset from a departure location to a destination location; and
the third computer making the first determination to either maintain the first course of action or to change the first course of action based on the digital photograph of the supply chain process, the process identifier, and the description of the supply chain process.

10.-26. (canceled)

27. A system for supply chain event management utilizing an autonomous vehicle, comprising:
a computing system operably communicating with a distributed ledger computer, the distributed ledger computer being a node of a distributed ledger;
the computing system capturing first event data during the execution of a supply chain process, and obtaining first and second attributes of the supply chain process;
the computing system making a first determination to either maintain a first course of action in the supply chain process or to change the first course of action in the supply chain process utilizing the first event data and the first and second attributes;
the computing system generating a first record having the first event data, the first and second attributes, and the first determination, and storing the first record therein;
the computing system sending the first record to the distributed ledger computer; and
the distributed ledger computer adding the first record to a first block and broadcasting the first block to a plurality of nodes of the distributed ledger to validate and store the first block on the distributed ledger.

28. The system of claim 27, wherein:
the computing system further calculating a hash value of the first record;
the computing system sending the hash value to the distributed ledger computer;
the distributed ledger computer adding the hash value to a second block and broadcasting the second block to the plurality of nodes of the distributed ledger to validate and store of the second block on the distributed ledger.

29. The system of claim 27, wherein:
the computing system further displaying the first record, and receiving input data that indicates a second determination relating to the first course of action of the supply chain process;
the computing system operably communicating with an external data source, the computing system obtaining a third attribute of the supply chain process from the external data source;
the computing system generating a second record having the first event data, the first, second and third attributes, and the first and second determinations, and storing the second record therein;
the computing system sending the second record to the distributed ledger computer; and
the distributed ledger computer adding the second record to a second block and broadcasting the second block to the plurality of nodes of the distributed ledger to validate and store the second block on the distributed ledger.

30. The system of claim 27, wherein the distributed ledger is at least one of a private distributed ledger or a public distributed ledger.

31. (canceled)

32. (canceled)

33. The system of claim 27, wherein:
the computing system capturing second event data during the execution of the supply chain process, and obtaining third and fourth attributes of the supply chain process;
the computing system making a second determination to either maintain a second course of action in the supply chain process or to change the second course of action in the supply chain process utilizing the second event data and the third and fourth attributes;
the computing system generating a second record having the second event data, the third and fourth attributes, and the second determination, and storing the second record therein;
the computing system sending the second record to the distributed ledger computer; and
the distributed ledger computer adding the second record to a second block and broadcasting the second block to the plurality of nodes of the distributed ledger to validate and store the second block on the distributed ledger.

34. The system of claim 33, wherein the first event data comprises raw data, and the first record comprises processed data, and the first and second records comprise meta event data.

35. The system of claim 27, wherein:
the computing system comprises first, second, third, and fourth computers operably communicating with one another, the third and fourth computer operably communicating with the distributed ledger computer;
the first computer capturing the first event data during the execution of the supply chain process, and obtaining the first attribute of the supply chain process that is stored therein, the first computer sending a first message to the second computer, the first message having the first event data and the first attribute of the supply chain process therein;
the second computer sending a second message to the fourth computer in response to the first message, the second message having the first attribute and requesting the second attribute of the supply chain process from the fourth computer;
the fourth computer obtaining the second attribute stored therein utilizing the first attribute in response to the second message, and sending a third message to the second computer having the second attribute therein in response to the second message;
the second computer sending a fourth message to the third computer; the fourth message having the first event data and the first and second attributes of the supply chain process therein;
the third computer making the first determination to either maintain the first course of action in the supply chain process or to change the first course of action in the supply chain process utilizing the first event data and the first and second attributes;
the third computer generating the first record having the first event data, the first and second attributes, and the first determination, and sending a fifth message having the first record therein to the fourth computer, and sending a sixth message having the first record therein to the distributed ledger computer;
the fourth computer storing the first record therein in response to the sixth message; and
the distributed ledger computer adding the first record to the first block and broadcasting the first block to the plurality of nodes of the distributed ledger to validate and store the first block on the distributed ledger, in response to the sixth message.

36. (canceled)

37. The system of claim 35, wherein:
the computing system further comprises fifth and sixth computers that operably communicate with the first, second, third, and fourth computers;
the fifth computer displaying the first record, and receiving the input data that indicates the second determination relating to the first course of action of the supply chain process, and sending a seventh message having the second determination to the third computer;
the sixth computer operably communicating with an external data source, the sixth computer obtaining a third attribute of the supply chain process from the external data source;
the sixth computer sending an eighth message having the third attribute therein to the third computer;
the third computer generating a second record having the first event data, the first, second and third attributes, and the first and second determinations, and storing the second record therein;
the computing system sending a ninth message having the second record therein to the distributed ledger computer; and
the distributed ledger computer adding the second record to a second block and broadcasting the second block to the plurality of nodes of the distributed ledger to validate and store the second block on the distributed ledger.

38. The system of claim 35, wherein:
the supply chain process is a transport of freight;
the first event data is a digital photograph captured during the supply chain process;
the first attribute is a process identifier of the supply chain process;
the second attribute is a second record providing a description of the supply chain process;
the first course of action is a transporting of freight by the supply chain asset from a departure location to a destination location; and
the third computer making the first determination to either maintain the first course of action or to change the first course of action based on the digital photograph of the supply chain process, the process identifier, and the description of the supply chain process.

39.-56. (canceled)

57. A system for supply chain event management utilizing an autonomous vehicle, comprising:
a first computer capturing first event data of a supply chain process, and obtaining first and second attributes of the supply chain process that are stored therein;
the first computer making a first determination to either maintain a first course of action in the supply chain process or to change the first course of action in the supply chain process utilizing the first event data and the first and second attributes;
the first computer generating a first record having the first event data, the first and second attributes, and the first determination, and storing the first record therein; and
the first computer adding the first record to a first block and broadcasting the first block to the plurality of nodes of a distributed ledger to validate and store the first block on the distributed ledger.

58. The system of claim 57, wherein:
the first computer calculating a hash value of the first record; and
the first computer adding the hash value to a second block and broadcasting the second block to the plurality of nodes of the distributed ledger to validate and store the second block on the distributed ledger.

59. The system of claim 57, wherein:
the first computer operably communicating with an external data source, the first computer obtaining a third attribute of the supply chain process from the external data source;
the first computer generating a second record having the first event data, the first, second and third attributes, and the first and second determinations, and storing the second record therein; and
the first computer adding the second record to a second block and broadcasting the second block to the plurality of nodes of the distributed ledger to validate and store the second block on the distributed ledger.

60. The system of claim 57, wherein:
the supply chain process is a transport of freight;
the first event data is a digital photograph captured during the supply chain process;
the first attribute is a process identifier of the supply chain process;
the second attribute is a second record providing a description of the supply chain process;
the first course of action is a transporting of freight by the supply chain asset from a departure location to a destination location; and
the first computer making the first determination to either maintain the first course of action or to change the first course of action based on the digital photograph of the supply chain process, the process identifier, and the description of the supply chain process.

61.-70. (canceled)
